(19) United States
(12) Patent Application Publication
(10) Pub. No.: US 2020/0331201 A1
(43) Pub. Date: Oct. 22, 2020

(54) A METHOD, A SYSTEM AND A PACKAGE FOR PRODUCING A THREE DIMENSIONAL OBJECT, AND A SENSING DEVICE COMPRISING A 3D OBJECT MANUFACTURED WITH THE METHOD

(71) Applicants: FUNDACIÓ INSTITUT DE CIÈNCIES FOTÒNIQUES, Castelldefels (ES); INSTITUCIÓ CATALANA DE RECERCA I ESTUDIS AVANÇATS, Barcelona (ES)

(72) Inventors: Alexandros Stavrinadis, Castelldefels (ES); Alexander Powell, Castelldefels (ES); Gerasimos Konstantatos, Castelldefels (ES); Romain Quidant, Castelldefels (ES)

(73) Assignees: FUNDACIÓ INSTITUT DE CIÈNCIES FOTÒNIQUES, Castelldefels (ES); INSTITUCIÓ CATALANA DE RECERCA I ESTUDIS AVANÇATS, Barcelona (ES)

(21) Appl. No.: 16/959,871

(22) PCT Filed: Jan. 2, 2019
(86) PCT No.: PCT/EP2019/050011

§ 371 Date: Jul. 2, 2020

(30) Foreign Application Priority Data
Jan. 4, 2018 (EP) 18382001.8

(51) Int. Cl. B29C 64/165; B33Y 10/00; B33Y 30/00; B33Y 50/02; B33Y 80/00; B33Y 70/00; B29C 64/393; B28B 1/00; B28B 17/00

(52) U.S. Cl. CPC B29C 64/165; B33Y 10/00; B33Y 30/00; B33Y 50/02; B33Y 80/00; B29L 2031/752; B29C 64/393; B28B 1/001; B28B 17/0081; B29K 2995/0018; B33Y 70/00

(57) ABSTRACT

The present application relates to a method for producing a three-dimensional object, comprising:—providing a first material (A) and, thereon, a second material (B) which is a reversible chromic material;—applying a stimulus to the second material (B) to change its optical properties from non-strong optical or substantially non-strong optical absorption properties to strong optical absorption properties, regarding a specific wavelength, and—exposing the second material (B) to electromagnetic radiation to be absorbed thereby to photothermally fuse portions of the first material (A) in thermal contact with the second material (B). A second aspect of the application relates to a system adapted to implement the method of the first aspect. A third aspect of the application concerns a kit of materials for producing a three-dimensional object. In a fourth aspect, the application relates to a sensing device comprising a three-dimensional object manufactured according to the method presented in the application.

### FIELD OF THE INVENTION

The present invention relates, in a first aspect, to a method for producing a three-dimensional (3D) object, by fusing at least partially a non-continuous material from heat generated by a reversible chromic material when acting as a radiation absorbent material upon changing its optical properties induced by a stimulus.

A second aspect of the invention relates to a system adapted to implement the method of the first aspect.

A third aspect of the present invention concerns to a package for producing a three-dimensional object, in collaboration with the system of second aspect of the invention.

In a fourth aspect, the present invention relates to a sensing device comprising a three-dimensional object manufactured according to the method of the first aspect of the invention.

The invention is particularly applied to the manufacturing of 3D objects using a layer-by-layer deposition process.

### BACKGROUND OF THE INVENTION

3D printing, also termed additive manufacturing, is widely used for the fabrication of solid objects. One method for 3D printing relies on the layer-by-layer sintering of granular materials into forming continuous solid objects (U.S. Pat. No. 5,155,324 A). Via this general method, a variety of granular materials can be processed into forming solid objects and a class of materials that can be processed this way is polymers. Sintering of such materials can be achieved via radiating them with electromagnetic radiation which is absorbed by the materials and results to the generation of heat and the raise of the material's temperature. When the temperature of the material exceeds the temperature required for sintering of the granules of the material, then sintering occurs and the material transforms from a non-continuous solid (where granules are not strongly bounded to each other) to continuous solid (where the granules are strongly bounded to each other). For polymer, the sintering temperature is numerically close to the melting temperature of the polymer, and thus the final object may not contain granules within it. All solid materials can absorb electromagnetic radiation and be heated, but the wavelength and the intensity of electromagnetic radiation that is required for achieving the aforementioned sintering effect depends on the material. Several polymers for example can be sintered by intense IR and mid-IR light and in the prior art direct sintering of these materials is achieved by radiating them with high intensity CO₂ IR lasers (U.S. Pat. No. 5,155,324 A). Such radiation sources are bulky and highly expensive and energy consuming and that hinders the large-scale application of this technology. This problem can be solved by introducing into the polymer at least one additional material that is known to exhibit very good photothermal response, that is to efficiently convert electromagnetic energy into heat, upon absorbing electromagnetic radiation from affordable and easy to integrate and operate radiation sources such as IR lamps or visible lasers or LEDs. For clarity these materials will be called Photothermal Sensitizers in the present document and abbreviated as PS. An example of such PS material is carbon black which is a broadband optical absorber with very good photothermal response (US 20140314613 A1). Nevertheless, the use of materials like carbon black imposes a secondary, yet important, technological problem. This problem is that the colour of the 3D printed object is strongly affected by the colour of the PS material that is enclosed in the objects' material. For example, when the PS is carbon black, and the main granular material sintered is a transparent or white or otherwise coloured polymer, this problem is significant because carbon black is black and the printed object will be black or darkened compared to the polymers' colour, depending on carbon black's concentration in the object.

For solving the colour-related problem, the use of PS materials that absorb only weakly visible electromagnetic radiation but absorb strongly non-visible electromagnetic radiation has been described in the prior art. Such previously described PS materials are permanently plasmonic particles of metals or heavily doped semiconductors. Such materials are good PS materials because they contain free electrons that resonate with external electromagnetic radiation. The thus stimulated electrons' motion is then dissipated via heating up the crystal structure of the PS material. This approach can solve only partially the colour-related problem because by nature the free electrons of the PS material can interact with a broad band of electromagnetic radiation. Consequently, although the free electrons' resonance with visible radiation may be weak, in practice it is also not negligible. Therefore, the use of permanently plasmonic PS materials does not solve completely the colour-related problem. In addition, 3D printing typically occurs at elevated temperatures which are close to the sintering temperature. At elevated temperatures, and under ambient environmental conditions, the morphology and chemical composition of the PS materials can be altered and this can further negatively affect the colour of the PS materials and consequently the colour of the printed object. For example, if the PS material is gold nanorods or gold nanoshells the shape of which has been engineered as to minimize their resonance with visible light, upon exposing the rods or shells to high temperatures their shape can be altered towards increasing their resonance with visible light and ultimately colouring the printed object. Finally, when the PS material is a heavily doped high bandgap semiconductor such as a heavily doped oxide material, e.g. aluminium doped zinc oxide, the high density of free carriers may result to alteration or effective narrowing of the optical bandgap of the material due to several well-known in the scientific literature physical effects such as the Burstein-Moss effect and the formation of Urbach absorption tail. This may translate to coloration of the material and of the composite printed object that contains such PS materials.

On the other hand, a number of patent documents describe the incorporation of photochromic or thermochromic materials in 3D printed objects which are made via the hot filament extrusion method and not via the sintering of granular materials method (US 20160347995 A1, CN 104149351 A, U.S. Pat. No. 9,404,200 B2). Nevertheless, in these cases the photochromic or thermochromic materials are used for being incorporated in the manufactured object, for aesthetic reasons or for adding photochromic and thermochromic functionalities to the 3D printed objects, but not for enabling the printing process itself.

International application WO2017146741 discloses a method for producing a three-dimensional object, comprising the features of the preamble of claim 1 of the present invention (for the embodiment shown in its FIG. 3), and also a method for colouring an object (in reference to its FIG. 1), which, for an embodiment, includes the use of a thermochromic material, particularly an oxide of Vanadium, although the thermochromic properties thereof are not induced. In contrast, the colour change provided with the oxide of Vanadium in WO2017146741 is provided by means of a chemical reaction with the substrate and is a permanent change of colour.

The only objective of the method for colouring an object disclosed in said International application is to develop a desired colour change for the object, not to link that colouring method with the 3D printing method disclosed therein, i.e. not to provide a colour absorption to a material for a specific EM wavelength (i.e. to match the optical absorption properties to a desired EM wavelength) in order to use that material for photothermally generate heat, when stimulated with a specific wavelength, to be used to fuse another material in a 3D printing process.

It is, therefore, necessary to provide an alternative to the state of the art which covers the gaps found therein, by providing a method and a system for producing a 3D object by fusing at least partially (sintering and/or melting) a non-continuous solid material with heat generated from a PS material, which do not possess the above mentioned drawbacks associated to the existing proposals which use permanently plasmonic PS materials, and which solve, among other problems, the above mentioned colour-related problem.

### SUMMARY OF THE INVENTION

To that end, the present invention relates, in a first aspect, to a method for producing a three-dimensional object, comprising:
providing a first material in a non-continuous solid form;
providing a second material on at least a region to be at least partially fused (for fusing together said region, such as by sintering and/or melting) of said first material, wherein said second material exhibits strong optical absorption properties at a specific wavelength, which make the second material a strong optical absorber; and
exposing said second material to electromagnetic radiation at said specific wavelength, to be absorbed thereby to photothermally generate heat to fuse at least those portions of the first material in thermal contact with the second material.

In contrast to the methods known in the prior art, the one of the first aspect of the present invention comprises, in a characterizing manner:
providing as said second material a reversible chromic material which changes its optical properties induced by a stimulus, from non-strong optical absorption properties or substantially non-strong optical absorption properties, at said specific wavelength, to said strong optical absorption properties at said specific wavelength; and
applying at least said stimulus to the second material to temporarily change its optical properties to said strong optical absorption properties at said specific wavelength, wherein at least said stimulus is applied before and/or during at least part of the time during which the second material is exposed to said electromagnetic radiation at said specific wavelength.

For an embodiment, called herein as resonance embodiment, said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

In other words, for said resonance embodiment, the present invention relates to a method for producing a three-dimensional object, comprising:
providing a first material in a non-continuous solid form;
providing a second material on at least a region to be at least partially fused (for sintering and/or melting) of said first material, wherein said second material exhibits optical resonant properties at a specific wavelength, which make the second material an optically resonance absorber; and
exposing said second material to electromagnetic radiation at said specific wavelength, to be absorbed thereby to optically resonate to photothermally generate heat to fuse at least those portions of the first material in thermal contact with the second material.

In contrast to the methods known in the prior art, the one of the resonance embodiment of the first aspect of the present invention comprises, in a characterizing manner:
providing as said second material a reversible chromic material which changes its optical properties induced by a stimulus, from optical non-resonant properties or optical substantially non-resonant properties, at said specific wavelength, to said optical resonant properties at said specific wavelength; and
applying at least said stimulus to the second material to temporarily change its optical properties to said optical resonant properties at said specific wavelength, wherein at least said stimulus is applied before and/or during at least part of the time during which the second material is exposed to said electromagnetic radiation at said specific wavelength.

For another embodiment, called herein as polaronic embodiment, said the strong optical absorption properties are optical polaronic properties, the strong optical absorber is an optical polaronic absorber, the non-strong optical absorption properties are non-strong optical polaronic properties, and the substantially non-strong optical absorption properties are substantially non-strong optical polaronic properties.

For a further embodiment, called herein as hybrid embodiment, the strong optical absorption properties comprise optical resonant properties and optical polaronic properties, the strong optical absorber is both an optical resonance absorber and an optical polaronic absorber, the non-strong optical absorption properties comprise optical non-resonant properties and non-strong optical polaronic properties, and the substantially non-strong optical absorption properties comprise optical substantially non-resonant properties and substantially non-strong optical polaronic properties.

Generally, for the polaronic and hybrid embodiments, the second material has a crystal lattice with defect sites, wherein the optical polaronic absorption comprises the absorption of the optical energy needed to move an electron between said defect sites, i.e. the energy needed to get over the gaps between defect sites. A distribution of optical energies is required for those transitions between the defect sites, so that a corresponding optical absorption band is associated with the second material that is optically selective, i.e. that includes very strong absorption areas for at least the above mentioned specific wavelength, and very weak absorption areas for other wavelengths.

Depending on the level of defects in the second material, and, if so, the other dopants present, as well as the coating choice and particle size and shape, either the resonant or the polaronic absorption could be the dominant mechanism.

Particularly, for a second material made of large particles, or very agglomerated particles, or particles with certain coatings, the strong optical absorption could be due only to polarons, i.e. according to the polaronic embodiment.

By means of the method of the first aspect of the present invention, the formation of the object, including the formation of the desired shape thereof, is performed by fusing together (generally by sintering) directly the first material in a non-continuous form (i.e. not from a green body), and, in contrast to the prior art, without the above mentioned colour-related problems that the use of permanent PS materials involves, as the operation as strong optical absorbers of the first material is conditioned to the application thereon of the above mentioned stimulus, thus also avoiding an accidental photothermal heat generation.

In order to clearly define the meaning of the terms strong and non-strong (or weak) optical absorption properties of the second material, an absorption coefficient is used herein using the well-known beer-lambert law, which relates the intensity of radiation entering into a medium, or input intensity, with the intensity of radiation outputting that medium, or output intensity, once radiation absorbance has been produced, where a sample of the second material is used as the medium:

$$A = {log}_{10} ( \frac{{I}_{0}}{I} ) = ϵ l c$$

Where A is the absorbance, I₀ and I are the input and output (measured) intensity, respectively, l is the second material sample thickness (in cm) traversed by the radiation, c is the concentration (in g.L⁻¹) and ϵ is the absorption coefficient with the units of L.g⁻¹.cm⁻¹.

Therefore, from the expression above, the terms “strong” and “non-strong” optical absorption properties, when referring to the second material, can be defined through absorbance spectroscopy. Specifically, this can be defined generally in terms of an absorption coefficient with units of L.g⁻¹.cm⁻¹.

The second material will be considered to be in a “non-strong” (i.e. weak) absorption state, i.e. exhibiting non-strong optical absorption properties, if, for a set of well dispersed particles of that second material, at the wavelength of the electromagnetic radiation to which the second material is exposed to photothermally generate heat, their absorption coefficient is less than 1 L.g⁻¹cm⁻¹, preferably less than 0.5 L.g⁻¹.cm⁻¹ and ideally less than 0.1 L.g⁻¹.cm⁻¹. The terms substantially non-strong optical absorption properties refer to the same absorption coefficient related to the non-strong optical absorption properties but with a certain tolerance (±10%).

When the second material is activated to produce its temporary, reversible chromic response, i.e. when the at least one stimulus is applied thereto, the second material will temporarily change its optical properties to the strong optical absorption properties, i.e. it will be considered to be in a “strong” absorption state if, for a set of well dispersed particles, at the wavelength of the above mentioned electromagnetic radiation, the absorption coefficient is greater than 2 L.g−1.cm—1, preferably greater than 3 L.g−1.cm−1, and ideally greater than 5 L.g−1.cm−1.

For both of these it is important to note the term “well dispersed”. This term will be clarified in a section below.

It must be noted that the use of chromic PS materials for utilizing their respective chromic properties as part of the manufacturing process has not been presented in the prior art.

The term “optical substantially non-resonant properties” is used in the present document to define the situation when, due to the exhibiting of said optical substantially non-resonant properties, the optical absorption coefficient of the second material for a given wavelength radiation, in this case to a radiation having the above mentioned specific wavelength, before being stimulated with the appropriate stimulus (i.e. the above mentioned stimulus), is at least 10 times smaller compared to the absorption coefficient of the second material to the same given wavelength radiation after being stimulated to the level used for generating heat for fusing at least partially the first material, i.e. for adopting the above mentioned optical resonant properties.

For an embodiment, the above mentioned optical non-resonant properties or optical substantially non-resonant properties of the reversible chromic material, refer not only to the above mentioned specific wavelength (i.e., the one used for the fusing step), but to any wavelength.

In contrast, for an alternative embodiment, the above mentioned optical non-resonant properties or optical substantially non-resonant properties of the reversible chromic material do not refer to any wavelength. In other words, there are one or more wavelengths, which is/are not said specific wavelength, to which the reversible chromic material is resonant before applying the above mentioned stimulus/stimuli.

For a first variant of said alternative embodiment, the change in the optical properties of the reversible chromic material, when the stimulus/stimuli is/are applied, refers to a shift in the wavelength to which the second material is resonant.

Alternatively, for a second variant of said alternative embodiment, the change in the optical properties of the reversible chromic material, when the stimulus/stimuli is/are applied, refers to the addition of a new spectral region of resonance to a pre-existing one. I.e., the second material, once said stimulus/stimuli is/are applied, becomes resonant to the above mentioned specific wavelength but it is still resonant to the one or more wavelengths which is/are not said specific wavelength.

For preferred embodiments of the method of the first aspect of the present invention, the reversible chromic material is:
a thermochromic material, and the above mentioned stimulus is a thermal stimulus; and/or
a photochromic material, and the above mentioned stimulus is an electromagnetic radiation stimulus.

For a skilled person in the art, it may be apparent that the method of the first aspect of the present invention can be generalized to cases where the second material is not necessarily a photochromic or/and a thermochromic material—i.e. it does not change optical properties under the application of an externally applied electromagnetic radiation or/and alteration of its temperature, respectively- but exhibits chromatic response to other types of external stimuli.

Therefore, for other embodiments of the method of the first aspect of the present invention, the reversible chromic material is:
a magnetochromic material; and/or
a solvatochromic material; and/or
a halochromic material; and/or
an electrochromic material; and/or
a chemochromic material.

More specifically, the stimulus can be a change in the magnetic field of the space around the second material, for the case the second material is a magnetochromic material, or a change in the density of the free charges of the space surrounding the second material, for the case the second material is an electrochromic material, or a change in the acidity or the alkalinity (which can be quantified by the pH) of the liquid solution that may surround the second material, for the case the second material is a halochromic material, ora change in the polarity of the liquid or gas or solids medium that may surround and is in contact with the second material, for the case the second material is a solvatochromic material, or a change in the density and types of chemical substances that may surround and/or are in contact with the second material, for the case the second material is a chemochromic material.

According to an embodiment, the reversible chromic material is excitable by different types of stimuli and/or comprises a combination of chromic materials differing in that they are excitable by different types of stimuli, wherein the above mentioned step of applying at least said stimulus to the second material comprises applying, sequentially or simultaneously, stimuli of said different types (such as those cited in the above paragraphs) to the second material.

In other words, the second material may also exhibit chromatic response to several ones or a combination of different external stimuli, i.e. the second material may be at the same time photochromic, thermochromic, solvatochromic, electrochromic, halochromic, magnetochromic, chemochromic or any combination of the above. In such case, a combination of different stimuli may be applied, simultaneously or sequentially, to the second material as to transform it from non-resonant or substantially non-resonant, at said specific wavelength, to resonant at said specific wavelength. For example, tungsten oxide (WO₃) particles, which are included as the second material for an embodiment of the method of the present invention, are known to be photochromic and electrochromic and chemochromic, and the photochromic property of WO₃ is also depended on the pH of the environment in which WO₃ is located, and thus several different types of stimuli can be applied separately or in combination for transforming the particles from non-resonant or substantially non resonant at said specific wavelength, to resonant at said specific wavelength.

Generally, the chromic effect is induced in the second material by the creation of additional carriers in response to the application of the stimulus/stimuli, so that at least some of said additional carriers change the optical absorption properties of the second material.

How those additional carriers effect the optical absorption properties, whether according to the above described resonance, polaronic or hybrid embodiments, will depend on different features, such as the ones explained above, i.e. the level of defects in the second material, dopants, coatings, particle size and shape, agglomeration degree.

Specifically, for WO₃ an important property of that material is that it is usually not pure WO₃, it generally has defects in the form of oxygen deficiencies, and so takes the form WO₍₃₋ₓ₎. A key paper by Salje & Güttler ([1])) shows that for different levels of x the behaviour of the additional carriers is very different.

For x<0.1, the transport is purely polaronic and this fully explains all of the optical absorption.

For x>0.1, there are too many additional carriers for only polaron-based transport, and many of the additional carriers act as free electrons.

Salje and Gutler ([1]) found that for WO_{2.72}, about half the additional carriers appear as polarons and the other half appear as free carriers. For a bulk material (particles with a diameter >>1 μm or for highly agglomerated dispersions of smaller particles), this means that the observed optical absorption (which is only due to polarons) is not as strong as it was predicted, as the free carriers in the bulk material do not contribute to IR absorption.

However for particles with diameters of less than about 1 pm, the particle geometry starts to effect the optical properties and so as well as polaronic absorption plasmonic absorption can be seen ([2,3]).

Several studies in WO₃ and doped WO₃, (e.g. CsWO₃) have shown that nanoparticles contain two distinct optical absorbance mechanisms, a plasmonic and a polaronic ones, although different studies have found different relative importances between the two. The relative importance will depend on the level of oxygen deficiency in the WO₃ (related to the number of defects), any other doping or defect atoms in the material, any coatings, and the size and shape of the nanoparticles.

Some examples of magnetochromic materials that can be used as second material for an embodiment of the method of the first aspect of the present invention are manganese tungsten oxide, bismuth ferrite (BiFeO₃), K₂V₃O₈.

Some examples of electrochromic materials that can be used as second material for an embodiment of the method of the first aspect of the present invention are tungsten oxide, nickel oxide (NiO) and polyaniline.

An example of a solvatochromic material that can be used as the second material for an embodiment of the method of the first aspect of the present invention is 4,4′-bis(dimethylamino)fuchsone.

An example of a halochromic material that can be used as the second material for an embodiment of the method of the first aspect of the present invention is methyl orange {4-[4-(Dimethylamino)phenylazo]benzenesulfonic acid sodium salt}.

Although, for an embodiment the method of the first aspect of the present invention is intended to produce a 3D object comprising only one layer (or slice) of a sintered/melted first material (having a thickness above the atomic scale, i.e. being a 3D layer), such as a flexible sheet, for a preferred embodiment the method comprises producing a 3D object using a layer-by-layer deposition process, by applying at least a further first material supply over the already sintered/melted first material, which forms a base layer, and then sintering/melting a region of said further first material supply as explained above regarding the base layer.

Additional first material layers can be provided and sintered/melted over the already sintered/melted and stacked layers, such that a final 3D product is obtained formed by a plurality of selectively sintered/melted regions having the same or different cross-sections.

In other words, the method of the first aspect of the present invention comprises, for an embodiment, producing a 3D object using a layer-by-layer deposition process, by forming a base layer as explained above, i.e. by fusing together the at least those portions of the first material in thermal contact with the second material (once submitted to the stimulus/stimuli) from the photothermal heat generated thereby, providing at least a further first material supply over the already formed base layer, and then fusing together a region of said further first material supply by applying a further second material supply thereon, applying thereon at least said stimulus and exposing to electromagnetic radiation having the specific wavelength the further second material supply.

Preferably, the method of the first aspect of the present invention comprises dispersing the optically second material within the first material, at least in the above mentioned region to be at least partially fused.

Generally, the first material is in the form of powder or granules, and the second material is in the form of particles.

For an embodiment, the step of providing the second material particles at least on said region to be at least partially fused of the powder first material, comprises providing them in a liquid or solution.

For an implementation of said embodiment, the liquid or solution with the second material particles is provided over a bed or layer formed by the powder first material, for example by spraying across the entire powder bed, or selectively through a mask, or selectively via the motion of the powder bed or a spray nozzle, such that the second material particles are dispersed as a spray above the powder bed. The spray nozzle may take the form of an inkjet print head, an atomizer or any other form of liquid dispersant.

For another embodiment, the second material particles are dispersed in a liquid above the powder bed. Multiple dispersant heads could be used for some implementations of said embodiment, containing the second material particles plus different coloured dyes to allow for colour 3D printing.

Alternatively, the powder first material is added to the liquid or solution containing the second material particles, for a period of time sufficient for the second material particles to adsorb onto the surface of the powder first material. The liquid is then dried leaving a powder mixed with the second material particles and the powder first material.

The method of the present invention comprises, for an embodiment, selecting said liquid or solution, and/or additives added thereto according to its wetting abilities on the powder material, to control the dispersion of the second material particles within the powder first material.

For a variant of said embodiment, the liquid or solution containing the second material particles is chosen to maximise wetting to the powder first material. This will enable the better penetration of the solvent into the gaps between the powder first particles or grains and therefore a better dispersion of the second material particles. The liquid or solution could be a single chemical, a mix of liquids, or a single liquid or mix of liquids with other chemicals dissolved within it to effect its wetting properties.

For an alternative variant of said embodiment, the liquid or solution containing the second material particles is chosen to minimise the wetting to the powder first material. This will enable the selectivity of placement of the second material particles in the edges and powder grain boundaries in the final produced object. The liquid or solution could be a single chemical, a mix of liquids, or a single liquid or mix of liquids with other chemicals dissolved within it to effect its wetting properties.

For another embodiment, the liquid or solution containing the second material particles is chosen to select the wetting to the powder first material in a way which neither minimises nor maximises the wetting properties, but is at least partially defined by some other factor, (e.g. heat capacity, latent heat of evaporation, cost, toxicity, etc.). This will still enable a good dispersion of the second material particles in the powder first second material but will also balance with other factors.

The step of providing the second material particles at least on a region of the powder first material, is performed, according to an embodiment, by selectively depositing the second material particles on one or more regions to be at least partially fused of the powder first material, and the fusing step, which is a sintering step, is performed by exposing to radiation the powder first material and the second material particles deposited on said one or more regions to be at least partially fused thereof. Said radiation exposure can be performed simultaneously over the whole bed formed by the powder first material and the second material particles, or along different portions thereof, for example by sweeping a light beam across said bed, and is produced once the second material particles have been stimulated so that they exhibit resonant optical properties at the specific wavelength of said radiation, or simultaneously to said stimulation.

Alternatively, the step of providing the second material particles at least on a region to be at least partially fused of the powder first material, is performed non-selectively on the whole powder first material, and the fusing step is performed by selectively exposing to radiation the powder first material and the second material particles provided on the one or more regions to be at least partially fused thereof, also once the second material particles have been stimulated so that they exhibit resonant optical properties at the specific wavelength of said radiation, or simultaneously to said stimulation. For another embodiment, the region to be at least partially fused of the first material is defined by selectively exposing this region to the stimulus that gives resonant optical properties to the second material.

Said non-selective provision of the second material particles on the whole powder first material can be performed in different ways, depending on the embodiment, some of which are described below:
by mixing the second material particles with all of the already provided powder first material;
by mixing the second material particles with a non-solid (for example, molten) or dissolved material, solidifying/drying the mixture and then turn the solidified/dried mixture into a powder form to produce mixture powder material including both the second material particles and the powder first material to be at least partially fused; or
by depositing the second material particles on all of the already provided powder first material.

For an embodiment, the second material particles are pre-mixed together with the powder first material in a dried form.

For another embodiment, the second material particles are pre-mixed together with the powder first material, either in a liquid or deposited as a powder themselves, and heat (or submitted to excitation radiation) is applied so that the second material particles are able to enter the surface of the powder first material particles, but not so that any fusing occurs. This would result in powder first material particles with second material particles embedded near their surface.

Preferably, the second material particles have an average cross-sectional length that is from 1 nm up to 5 μm, preferably below 100 nm.

For both the resonance and the hybrid embodiments, the second material particles have an average cross-sectional length that is from 1 nm up to 1 μm.

For the polaronic embodiment, the second material particles have an average cross-sectional length that is larger than 1 μm.

Usually, only polaronic absorption will be present for WO₃ particles greater than 1 micron in diameter, or for highly agglomerated dispersions of smaller particles, regardless of the oxygen deficiencies of the particles. For any Tungsten oxide particles (WO₃₋ₓ) of any size and dispersion, with an oxygen deficiency of less than x=0.1, the absorption will also be exclusively polaronic.

For well-dispersed WO₃₋ₓ particles with diameters less than 1 micron, and larger oxygen deficiencies, (x>0.1) and therefore greater free carrier densities, the absorption can have a resonant and a polaronic/non-resonant component. The relative importance of each mechanism in this case depends on the value of x, and the size and shape of the particle.

To be more specific, for well dispersed particles in water, particles with a small size, (<100 nm) and with larger oxygen deficiencies (x>0.28) are more likely to be more strongly plasmonic (resonant), and larger particles (x-section >500 nm) with smaller oxygen deficiencies (x<0.2) are likely to be more dependent on polaronic effects. However, factors such as shape and environmental conditions also play a big role here, and so this is not a hard rule.

In terms of the sizes, this should be true for all materials. In terms of the oxygen deficiency, this is specific at least to Tungsten oxide and its bronzes. Other materials (such as ITO) can be wholly resonant. For a preferred embodiment, the method of the first aspect of the present invention comprises applying the stimulus or stimuli during all of the time during which the second material is exposed to said electromagnetic radiation.

For other embodiments, the stimulus or stimuli are applied only during part of the time during which the second material is exposed to the electromagnetic radiation, and/or before that electromagnetic radiation exposure.

Depending on the embodiment, the optical resonance of the optically resonant absorber refers to at least one of the following types of optical resonances: plasmonic resonance, Mie resonance, whispering gallery modes, optical resonance due to electronic transitions of charge carriers from one energy state or band in the electronic structure of the second material to another one upon absorption of photons, or a combination thereof.

For some embodiments, the second material also comprises non-chromic materials, such as, preferably, non-chromic materials adapted and arranged to enable or enhance the chromic response of the chromic material or chromic materials.

Other non-chromic materials comprised by the second material, for some embodiments, are colorants, electrically conductive materials, permanently magnetic materials, paramagnetic materials, thermally conductive materials, high electrical capacitance materials, etc., or a combination thereof.

According to an embodiment of the method of the first aspect of the present invention, the second material and the first material are mixed together, at least in the above mentioned region to be at least partially fused, with a weight ratio from 0.01:1000 to 300:1000, preferably from 0.1:1000 to 100:1000, most preferably from 1:1000 to 10:1000.

For an embodiment, the first and second materials form a composite, where the first material is the main constituent of the composite and the second materials is in an amount which is minute compared to the first material, such as in the weight ratio mentioned above.

Although other materials non mentioned here can be used to constitute the second material, for some embodiments the second material includes at least one of the following materials: vanadium oxide, tungsten oxide, aluminium doped zinc oxide, tin doped indium oxide, cesium doped tungsten oxide, copper doped tungsten oxide, potassium doped tungsten oxide, sodium doped tungsten oxide, silver doped tungsten oxide, or a combination thereof.

Other compounds (organic or inorganic or hybrid) that possess such chromic properties and that are not necessarily in nanocrystalline form (i.e. they can be molecular species, sol-gel or amorphous materials) can also be used to constitute the second material, for other embodiments.

The present invention also relates, in a second aspect, to a system for producing a three-dimensional object, comprising:
at least one supplier device for providing:
   a first material in a non-continuous solid form; and
   a second material on at least a region to be at least partially fused of said first material, wherein said second material exhibits strong optical absorption properties at a specific wavelength, which make the second material be a absorption optical absorber;
a controllable radiation source for exposing said second material to electromagnetic radiation at said specific wavelength, to be absorbed thereby to photothermally generate heat to fuse at least those portions of the first material in thermal contact with the second material, and
at least one controller adapted to control said at least one supplier device to provide the first and the second materials, and said controllable radiation source to emit said electromagnetic radiation at said specific wavelength, to expose the second material thereto.

In contrast to the systems known in the prior art, the one of the second aspect of the present invention comprises, in a characterising manner:
a supply of the second material, to feed the at least one supplier, in the form of a reversible chromic material which changes its optical properties induced by a stimulus, from non-strong optical absorption properties or substantially non strong optical absorption properties, at said specific wavelength, to said strong optical absorption properties at said specific wavelength; and
a stimulus source configured and arranged to apply at least said stimulus to the second material to temporary change its optical properties to said strong optical absorption properties at said specific wavelength.

The above mentioned at least one controller is also adapted to control said stimulus source to apply at least said stimulus to the second material before and/or during at least part of the time during which the second material is exposed to said electromagnetic radiation at said specific wavelength, that is generated by said controllable radiation source.

For an embodiment, called herein resonance system embodiment, for which the system is adapted for implementing the above mentioned resonance embodiment of the method of the first aspect of the present invention, said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

In other words, for said resonance system embodiment, the present invention relates to a system for producing a three-dimensional object, comprising:
at least one supplier device for providing:
   a first material in a non-continuous solid form; and
   a second material on at least a region to be at least partially fused of said first material, wherein said second material exhibits optical resonant properties at a specific wavelength, which make the second the second material an optically resonance absorber;
a controllable radiation source for exposing said second material to electromagnetic radiation at said specific wavelength, to be absorbed thereby to optically resonate to photothermally generate heat to fuse at least those portions of the first material in thermal contact with the second material, and
at least one controller adapted to control said at least one supplier device to provide the first and the second materials, and said controllable radiation source to emit said electromagnetic radiation at said specific wavelength, to expose the second material thereto.

In contrast to the systems known in the prior art, the one of the resonance system embodiment of the second aspect of the present invention comprises, in a characterising manner:
a supply of the second material, to feed the at least one supplier, in the form of a reversible chromic material which changes its optical properties induced by a stimulus, from optical non-resonant properties or optical substantially non-resonant properties, at said specific wavelength, to said optical resonant properties at said specific wavelength; and
a stimulus source configured and arranged to apply at least said stimulus to the second material to temporary change its optical properties to said optical resonant properties at said specific wavelength.

The above mentioned at least one controller is also adapted to control said stimulus source to apply at least said stimulus to the second material before and/or during at least part of the time during which the second material is exposed to said electromagnetic radiation at said specific wavelength, that is generated by said controllable radiation source.

For another embodiment, called herein as polaronic system embodiment, for which the system is adapted for implementing the above mentioned polaronic embodiment of the method of the first aspect if the present invention, the strong optical absorption properties are optical polaronic properties, the strong optical absorber is an optical polaronic absorber, the non-strong optical absorption properties are non-strong optical polaronic properties, and the substantially non-strong optical absorption properties are substantially non-strong optical polaronic properties.

For another embodiment, called herein as hybrid system embodiment, for which the system is adapted for implementing the above mentioned hybrid embodiment of the method of the first aspect if the present invention, the strong optical absorption properties comprise optical resonant properties and optical polaronic properties, the strong optical absorber is both an optical resonance absorber and an optical polaronic absorber, the non-strong optical absorption properties comprise optical non-resonant properties and non-strong optical polaronic properties, and the substantially non-strong optical absorption properties comprise optical substantially non-resonant properties and substantially non-strong optical polaronic properties.

Said at least one controller is implemented, depending on the embodiment, by means of only one controller or by means of two or more controllers.

Depending on the embodiment, all of the above mentioned elements of the system of the second aspect of the invention are locally implemented in the same apparatus, or distributed in different and independent apparatuses.

An example of said implementation of the elements of the system distributed in different and independent apparatuses, is that for which the stimulus source or stimuli sources, and corresponding controller are placed remotely to the rest of elements of the system of the second aspect of the invention, so that the stimulus/stimuli is/are applied to the supply of second material, and then the supply of second material is fed to the at least one supplier already with optical resonant properties at said specific wavelength.

The system of the second aspect of the present invention is adapted to implement the method of the first aspect, for all the embodiments of the method that are described in the present document.

For an embodiment of the system of the second aspect of the invention, associated at least to the above mentioned embodiment of the method of the first aspect for which the second material particles are mixed with a non-solid first material to finally produce a mixture powder material, the above mentioned at least one supplier device is a common supplier device which provides said mixture powder material, i.e. provides simultaneously both the first material and the second material.

On the other hand, for those embodiments of the method for which the powder first material is first provided and the second material particles are then provided thereon, advantageously said at least one supplier device are at least two supplier devices, one for supplying the powder first material and another for supplying the second material particles.

For an embodiment, the system of the second aspect of the invention is a 3D printer (implementing techniques such as selective laser sintering (SLS) or high speed sintering (HSS) using inkjet heads to disperse the particles) which comprises also well-known features common to conventional 3D printers (such as movables carriages, ejection systems, actuation and driving mechanisms including electric motors, electric and electronic systems, etc.), which are not described herein in detail to avoid obscuring the present invention.

For an embodiment, the above mentioned at least one controller includes a memory, program code residing in the memory, and a processor in communication with the memory and configured to execute the program code to generate control signals to apply to at least the controllable radiation source, the stimulus source (or stimuli sources) and to the at least one supplier device, to carry out the control of the operations thereof.

As stated above, the use of magnetochromic, or electrochromic, or halochromic, or solvatochromic or chemochromic materials as the second material is also covered by the present invention, for some embodiments, both for the method of the first aspect and also for the system of the second aspect provided that for each case an appropriate subsystem is included in the overall printing apparatus. The purpose of such subsystem is to stimulate a change in the optical properties of the second material B and for transforming it, from non-resonant or substantially non-resonant, at said specific wavelength, to resonant at said specific wavelength. For example, for a magnetochromic second material, the aforementioned subsystem can include at least one magnet or electromagnet, which is operated as to induce a temporary change of the magnetic field around second material. For an electrochromic second material, the aforementioned subsystem can for example include at least source of electrically charged particles, such as an electron gun, which is operated as to induce a temporary change of the flow of charged particles such as electrons that hit second material. In another example, for an electrochromic second material, and for the case where the particles of the electrochromic second material are applied and dispersed through an inkjet or spray nozzle, the aforementioned subsystem can include a set of electrodes via which a voltage is applied across the aperture of the spray or inkjet nozzle which could charge the particles as they are dispersed through the nozzle. For a halochromic second material, the aforementioned subsystem can for example include at least one dispenser of mildly or strongly acidic or alkali solutions, which is operated as to induce a temporary change of the pH of the medium that surrounds second material. For a solvatochromic second material, the aforementioned subsystem can for example include at least one dispenser of a solvent or a mixture of solvents, which is operated as to induce a temporary change of the solvents and substances that may surround and are in contact with second material. For a chemochromic second material, the aforementioned subsystem can for example include at least one dispenser of at least one chemical substance, which is operated as to induce a temporary change of type and concentration of the substances that may surround and/or are in contact with the second material.

In all cases, the externally provided stimulus to the second material can be applied before, during or after the second material is mixed with the first material and/or irradiated with the electromagnetic radiation at said specific wavelength at which the second material becomes resonant upon the application of the external stimulus. In all cases, it is preferable (although not essential) if the second material becomes instantly or progressively non-resonant or substantially non-resonant, at said specific wavelength, once the external stimulus is no longer applied. In the case of a halochromic or solvatochromic or chemochromic second material, the external stimulus can for example be ceased once the liquids and substances applied to the second material are evaporated.

The present invention also relates, in a further aspect, to a computer program, comprising computer program components including code instructions that when executed on one or more processors of the at least one controller of the system of the second aspect of the invention implement the above mentioned generation of control signals (in digital form, to be converted to electrical signals) to carry out the control of the operations of the controllable radiation source, stimulus source, and of the at least one supplier device.

A third aspect of the present invention relates to a package for producing a three-dimensional object, comprising, enclosed therein:
a first material in a non-continuous solid form; and
a second material which exhibits strong optical properties at a specific wavelength which make the second material be a strong optical absorber;
wherein said second material is a reversible chromic material which changes its optical properties induced by a stimulus, from non-strong optical absorption properties or substantially non-strong optical absorption properties, at said specific wavelength, to said strong optical absorption properties at said specific wavelength, and wherein the package is configured and arranged to cooperate with the at least one supplier device of the system of the second aspect of the present invention for providing the first and second materials extracting them from the package.

For an embodiment, called herein resonance package embodiment, for which the package is adapted to the above mentioned resonance system embodiment of the system of the second aspect of the present invention, said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

In other words, for said resonance package embodiment, the present invention relates to a package for producing a three-dimensional object, comprising, enclosed therein:
a first material in a non-continuous solid form; and
a second material which exhibits optical resonant properties at a specific wavelength which make the second material an optically resonance absorber;
wherein said second material is a reversible chromic material which changes its optical properties induced by a stimulus, from optical non-resonant properties or optical substantially non-resonant properties, at said specific wavelength, to said optical resonant properties at said specific wavelength, and wherein the package is configured and arranged to cooperate with the at least one supplier device of the system of the second aspect of the present invention for providing the first and second materials extracting them from the package.

For another embodiment, called herein as polaronic package embodiment, for which the package is adapted to the above mentioned polaronic system embodiment of the system of the second aspect of the present invention, the strong optical absorption properties are optical polaronic properties, the strong optical absorber is an optical polaronic absorber, the non-strong optical absorption properties are non-strong optical polaronic properties, and the substantially non-strong optical absorption properties are substantially non-strong optical polaronic properties.

For another embodiment, called herein as hybrid package embodiment, for which the package is adapted to the above mentioned hybrid system embodiment of the system of the second aspect of the present invention, the strong optical absorption properties comprise optical resonant properties and optical polaronic properties, the strong optical absorber is both an optical resonance absorber and an optical polaronic absorber, the non-strong optical absorption properties comprise optical non-resonant properties and non-strong optical polaronic properties, and the substantially non-strong optical absorption properties comprise optical substantially non-resonant properties and substantially non-strong optical polaronic properties. Depending on the embodiment, both of the package and of the system to which is to be associated, the package of the third aspect of the invention comprises:
a common chamber within which both the first material and the second material are mixed, to be delivered together to the above mentioned common supplier device of the system of the second aspect of the invention, or
two chambers for respectively housing the first and the second materials, to be independently delivered to the two supplier devices of the system of the second aspect of the invention.

For an embodiment, said package is an ink print cartridge and the material is in the form of an ink for a 3D printing system.

Said ink print cartridge comprises also well-known features common to conventional ink print cartridges (such as an ejection system electrically controlled to eject ink, including one or more ink nozzles and associated electric circuitry, etc.), which are not described herein in detail to avoid obscuring the present invention.

A fourth aspect of the present invention relates to a sensing device comprising a three-dimensional object manufactured according to the method of the first aspect of the present invention, wherein the second material is arranged within the object so that its optical properties change from non-strong optical absorption properties or substantially non-strong optical absorption properties, at said specific wavelength, to strong optical absorption properties at said specific wavelength, upon detection of one or more stimuli inducing said change, so that phenomena causing said one or more stimuli can be sensed, detected and even measured when, for some embodiments, the sensing device includes associated measuring components (electric and/or electronic components, processing components, etc.).

For an embodiment, the three-dimensional object of the sensing device is manufactured according to the resonance embodiment of the first aspect of the present invention, so that said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

For other embodiments, the three-dimensional object of the sensing device is manufactured according to the polaronic embodiment or the hybrid embodiment of the first aspect of the present invention.

By means of the present invention, in all its aspects, the manufacturing/printing of three-dimensional (3D) objects from composite materials the optical properties of which when the objects are used, are not the same as the colour of the materials when the objects are being printed, is provided. This allows for using materials the optical properties of which are desirable for the objects but undesirable for existing 3D printing methods based on the sintering/melting process of granular materials. Examples of such methods are the selective layer sintering (SLS) method or the high speed sintering (HSS) printing method.

This further allows for using light sources of radiation the financial cost and energy consumption of which are lower compared to the cost of the radiation sources required for 3D printing objects of similar colour quality via using previous 3D printing technologies. Finally, the present invention can be used for making coloured objects the optical properties of which may change upon exposure of the objects at electromagnetic radiation or/and temperature variations (and/or under the presence of any of the above mentioned stimulus depending on the type of chromic properties that the second material has) and this property can be used for aesthetic reasons, for recreational purposes, or for the above mentioned sensing application, to sense the presence and even variations of certain stimulus or stimuli presence.

### BRIEF DESCRIPTION OF THE FIGURES

In the following some preferred embodiments of the invention will be described with reference to the enclosed figures. They are provided only for illustration purposes without however limiting the scope of the invention.

FIG. 1a summarizes the steps of the method of the first aspect of the present invention, for an embodiment for which the second material, identified as material B, is a photochromic material.

FIG. 1b summarizes the steps of the method of the first aspect of the present invention, for an embodiment for which the second material, identified as material B, is a thermochromic material.

FIG. 2 schematically shows the system of the second aspect of the present invention, for an embodiment.

FIG. 3 shows a 3D dimensional object manufactured according to the present invention, for an embodiment.

FIG. 4 is a plot showing the variation in the optical properties of nanoparticles of tungsten oxide in an ethanol solution, when submitted to ambient conditions and exposed to UV light, for an experiment for which said nanoparticles are selected as the second material for performing the method of the first aspect of the present invention, for an embodiment.

FIG. 5 is a plot which shows the time-dependent evolution of plasmon peak after UV treatment of the solution used for FIG. 4, particularly a 1 g/L colloidal solution.

FIG. 6 is a plot representative of an in-situ observation of photochromism of the 1 g/L colloidal solution under 365 nm UV-pumping.

FIGS. 7A and 7B graphically show the variation in temperature of disks formed from a dry composite sample of the nanoparticles/ethanol solution used for FIG. 2 mixed with a polymeric powder (first material), before and after being submitted to an UV stimulus, for a laser of 0.5 W/cm² (FIG. 7A) and a laser of 3 W/cm² (FIG. 7B).

FIG. 8 shows the evolution of photothermal property of the dry composite sample used for FIGS. 7A and 7B, at room temperature after UV-doping.

FIG. 9 is a graph showing the results of a photodoping-photothermal study of a 1:1000 weight ratio WO₃/PA12 powder at 125° C. under 3 W/cm² 808 nm laser and UV-light.

FIG. 10 is a graph that shows the photothermal degradation of the 1:1000 WO₃/PM12 powder after UV light is turned off, while laser 808 nm 3 W/cm² is constantly on. Linear fits are provided.

FIGS. 11A and 11B show, by means of two graphs, the results of a photodoping-photothermal study of the 1:1000 weight ratio WO₃/PM12 powder at 168° C. under 3 W/cm2 808 nm laser and UV-light, without (FIG. 11A) and with (FIG. 11B) an additional drop of WO₃.

FIG. 12 is a diagram showing optical absorption waveforms of well and poorly dispersed second material particles, specifically for WO₃ particles.

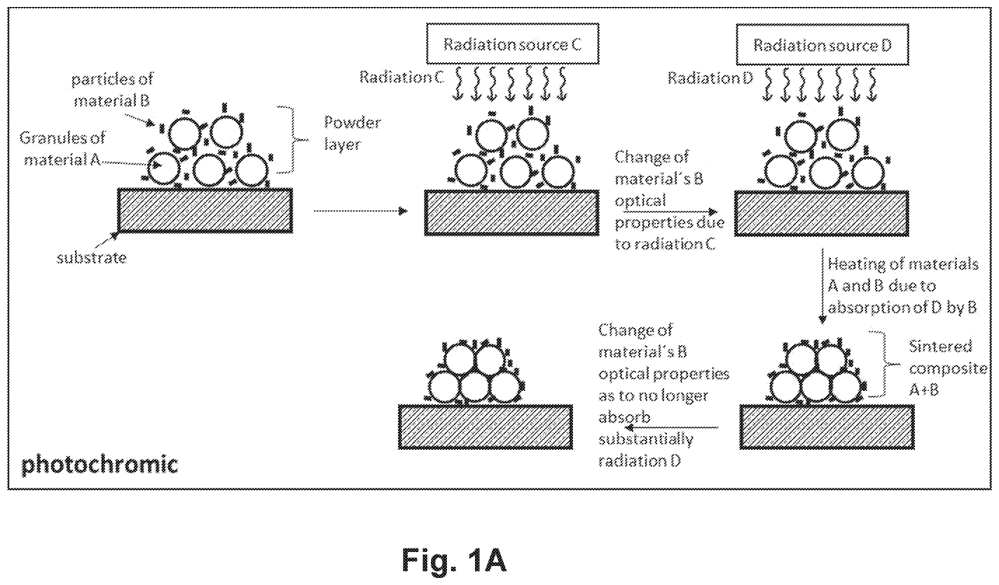

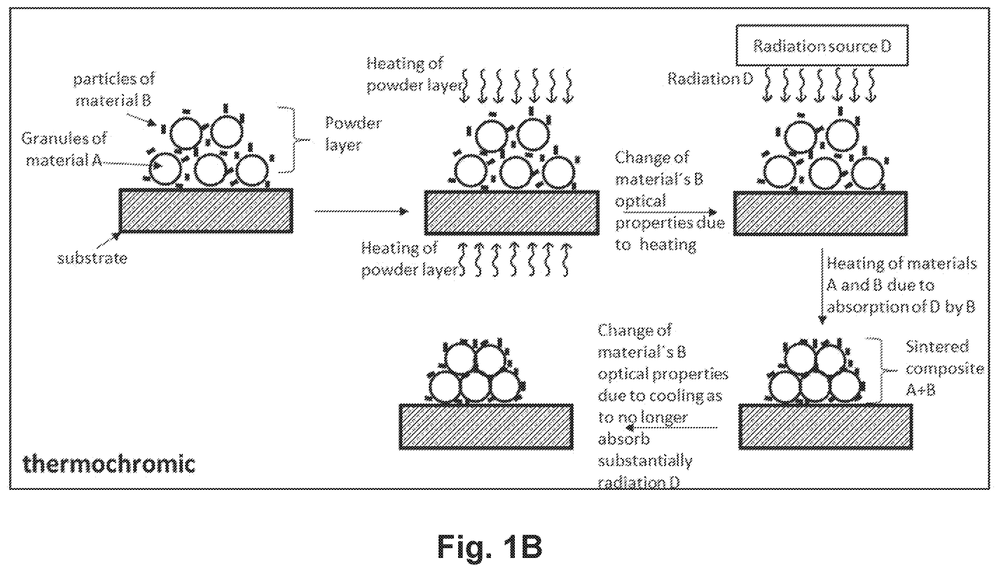

### DESCRIPTION OF THE PREFERRED EMBODIMENTS

In its generalized form, the method of the first aspect of the invention can be used for printing coloured objects made of composites of at least two materials, a material A (called first material in other parts of the present document) which is the main constituent of the composite and a material B (called second material in other parts of the present document) the amount of which is minute compared to A. Originally the composite is at a non-continuous solid form, such as in a powder form. It is noted that the temperature of the composite can be room temperature or a different temperature such an elevated (compared to room) temperature which however is lower than the sintering temperature of material A. Before or after material B is mixed with material A, material B on its own or the entire A+B composite are irradiated with electromagnetic radiation C or/and are heated at an elevated temperature (compared to room temperature) as to change the optical properties of material B and render it capable of absorbing a second form of electromagnetic radiation called radiation D. If the optical properties of material B can be changed by radiation C then material B is a photochromic material while if the optical properties of B are changed by a change of the temperature, material B is thermochromic material. Material B can be both photochromic and thermochromic (and/or of any of the other chromic types cited above). Radiation D is then applied to the composite and is absorbed mainly or exclusively by material B and causes heating of material B. Part of the heat is passed to material A and results to sintering of the powder into forming a continuous solid object. When subsequently, the sintered solid composite cools to room temperature and is no longer irradiated with radiation C, material B acquires its original optical properties.

The method of the first aspect of the present invention is summarized in Figures la and 1 b, for the cases of thermochromic and photochromic material B, respectively. This allows for printing objects the optical properties of which at the time of their use are not restricted by the optical properties required for the formation of the objects. For example, if material B at room temperature and ambient indoors or outdoors lighting conditions is visibly transparent or white but at high temperatures or/and under radiation B becomes coloured and resonant to visible radiation D, then radiation D can be used for printing the object but when printing is finished the object will no longer optically absorb visible radiation D, as long as material A also does not absorb radiation D.

Material A can actually consist of a set of materials of different chemical compositions such as a set of materials A1, A2, A3, etc., the common characteristic of which is that they do not absorb strongly the electromagnetic radiation D and they do not present a respective photothermal effect as strongly and as efficiently as material B. In addition material A or a set the materials A1, A2, A3, etc. may or may not belong to the same class of materials such as polymers. For example the set of materials A1, A2, A3, . . . , may contain within it the main material to be sintered as well as other additives which may serve additional functionalities such as to provide more efficient or strong binding of the granules upon sintering, or to colour the final object, or to add other functionalities in the final object such to render it electrically conductive or permanently magnetic or paramagnetic or thermally conductive, or to prevent coagulation of the granules of either material A or B or both before binding, or to prevent chemical transformation and chemical reactions of either materials A or B or both, before or after sintering. Nevertheless, materials A1, A2, A3 may also chemically react with each other and with material B before or after sintering. Material A or at least one constituent of the set of materials A1, A2, A3 is the main constituent of the composite of the object that is printed with the method of the present invention. In a specific example, this material is polymer. A non-limiting list of polymer materials that can be used with the method of the invention is: Polylactic Acid (PLA), Acrylonitrile Butadiene Styrene (ABS), PolyAmide (PA), High Impact Polystyrene (HIPS), Thermoplastic Elastomer (TPE). Herein, for clarity of presentation the term material A is used indistinguishably to describe either a single material or a set of materials A1, A2, A3, etc.

Material B can actually consist of a set of materials of different chemical compositions such as a set of materials B1, B2, B3, etc., which may have the common characteristic that their optical properties change upon absorbing the electromagnetic radiation C or upon being heated, and due to the change in their optical properties they can absorb electromagnetic radiation D and upon this process they present a significant photothermal effect. In addition, a set of materials B1, B2, B3 etc. may include at least one material which exhibits photochromism or thermohromism and the rest of the materials in the set are used to further enable or enhance the photothermal or photochromic response of the aforementioned member of the set, for example by chemically reacting with it, or by forcing it to change its atomic or crystalline structure upon heating, or/and irradiating the material set with radiation D. Material B or a set of materials B1, B2, B3, etc., and any individual member of such set of materials can also have additional functionalities. For example, they may also serve to colour the final object, or to add other functionalities in the final object such as to render it electrically conductive or permanently magnetic or paramagnetic or thermally conductive or to exhibit high electrical capacitance. For clarity of presentation, herein the term material B is used indistinguishably to describe either a single material or a set of materials B1, B2, B3, etc.

Thermochromic or photochromic materials B can be materials whose optical properties change upon being heated or/and absorbing electromagnetic radiation C due to a number of, known from the scientific literature, different physical effects such as: change of the material's structure, or change of the material's stoichiometry or an increase in the number of free charge carriers. Material B can be organic or inorganic or molecular or in the form of particles of various dimensions such as nanoparticles or larger size particles or thin flakes which may be amorphous or crystalline or polycrystalline. An example of thermochromic materials that can be used with the method of the present invention is vanadium oxide which when heated at temperatures above 50° C. starts absorbing strongly infrared light due to temperature induced change of its crystal structure. An example of photochromic material that can be used with the method of the present invention is tungsten oxide which upon absorbing ultraviolet (UV) electromagnetic radiation changes colour and also develops optical absorption of infrared electromagnetic radiation due to an increase in the number of free charge carriers in the material due to UV-light induced change in the stoichiometry of the material, namely a change in the oxygen to tungsten ratio. In a different example, tungsten oxide is used in combination with water molecules around it or within its structure because water is known to promote the photochromic response of tungsten oxide (Journal of Applied Physics 74, 4527 (1993)). Another example of material that can be used with the method of the present invention is aluminium doped zinc oxide which upon either absorption of ultraviolet light or increase of its temperature may change its visible colour and absorb more strongly infrared light due to an increase in the number of its free charge carriers due to a change in the cation to anion ratio of the material, or/and an increase of the number of electronically activated dopant atoms of the material, or/and due to an increase of the number of charge carriers populating the conduction band of the material.

A non-limiting list of thermochromic material categories members of which can be used with the method of the present invention is: Spiropyrans and spirooxazines, Diarylethenes, Azobenzenes, Photochromic quinones, inorganic photochromics. A non-limiting list of inorganic photochromics that can be used with our method is: silver chloride, silver halides, zinc halides, yttrium hydride, tungsten oxide and tungsten oxide bronzes, molybdenum oxide and molybdenum oxide bronzes, vanadium oxide and vanadium oxide bronzes, zinc oxide and aluminium doped zinc oxide, indium oxide and tin-doped indium oxide, titanium oxide, and in general binary or ternary or quaternary or more complex oxides which may be further alloyed between them or with other metal oxides or doped with various cations such as metals such as tin, lithium, copper, sodium, potassium, cesium, silver, lead, cadmium, iron, or doped with anions such halide atoms or chalcogen atoms.

A non-limiting list of thermochromic materials that can be used with the method of the present invention is: leuco dyes such as spirolactones, fluorans, spiropyrans, and fulgides, Cuprous mercury iodide (Cu₂Hgl₄), Silver mercury iodide (Ag₂Hgl₄), Mercury(II) iodide, Bis(dimethylammonium) tetrachloronickelate, Bis(diethylammonium) tetrarchlorocuprate, Chromium(III) oxide:aluminium(III) oxide, CdₓZn₁₋ₓS_{y}Se_{1-y} (x=0.5-1, y=0.5-1), ZnₓCd_{y}Hg_{1-x-y}OₐS_{b}Se_{c}Te_{1-a-b-c} (x=0-0.5, y=0.5-1, a=0-0.5, b=0.5-1, c=0- 0.5), HgₓCd_{y}Zn_{1-x-y}S_{b}Se_{1-b} (x=0-1, y=0-1, b=0.5-1), molybdenum oxide and molybdenum oxide bronzes, vanadium oxide and vanadium oxide bronzes, zinc oxide and aluminium doped zinc oxide, indium oxide and tin-doped indium oxide, titanium oxide, and in general binary or ternary or quaternary oxides which may be alloyed between them or with other metal oxides or doped with various cations such as metals such as tin, lithium, copper, sodium, potassium, cesium, silver, lead, cadmium, iron, or doped with anions such as halide atoms or chalcogen atoms.

Electromagnetic radiation C can be in the form of microwaves or visible light or UV or NIR, or mid-IR of far-IR electromagnetic waves or a combination of these, which can be produced through a variety of radiation sources. A non-limited list of such radiation sources is: laser, UV lamps, LED, halogen lamps, IR-lamps. The wavelength and intensity of the electromagnetic irradiation is chosen as to preferentially or completely be absorbed by material B and change its optical properties so as to absorb efficiently radiation D and consequently be heated due to the photothermal effect. Electromagnetic radiation C can contain electromagnetic waves of several different wavelengths all of some of which can be absorbed by material B and change its optical properties in the aforementioned manner.

Electromagnetic radiation D can be in the form of microwaves or visible light or UV or NIR, or mid-IR of far-IR electromagnetic waves or a combination of these, which can be produced through a variety of radiation sources. A non-limited list of such radiation sources is: laser, UV lamps, LED, halogen lamps, IR-lamps. Electromagnetic radiation D can contain electromagnetic waves of several different wavelengths all or some of which can be absorbed by material B and cause it to heat up.

In a preferred example of the method of the present invention material B is in the form of inorganic nanoparticles or micron-size particles since such small size particles can exhibit enhanced photochromic or/and thermochromic properties compared to larger size particles of the same material. This happens because small particles have an increased surface-to-volume ratio compared to larger particles and may require less energy for changing their stoichiometry, or structure, or surface chemistry, or free charge carrier density compared to larger size particles of the same material. A more specific example of such material, is tungsten oxide nanoparticles which are smaller than 100 nm. The surface of the nanoparticles or microparticles can be covered with other organic or inorganic materials such as atoms, molecules or other crystalline or non-crystalline materials which may be used for several purposes such as to enhance the photochromic properties of the particles, or to prevent their aggregation or to chemically stabilize the particles or to prevent sintering between the particles of material B or to prevent their interaction with material A or B or other materials such as gases such as atmospheric oxygen, or to control their optical, photothermal and other physical properties. For example, the surface of nanoparticles can be covered with molecules which act as anti-agglomeration agents and may belong to the following non-limiting list of chemical compounds and compound categories: Cetyltrimethyl ammonium bromide (CTAB) or others alkyl trimethyl ammonium halides (Lauryltrimethylammonium bromide (DTAB), Myristyltrimethylammonium bromide (MTAB), etc.), Polyethylene glycol (PEG) and derivatives, polyvinylpyrrolidone (PVP), Polycationic polymers such as polyvinylpyrrolidone, polyethylene imine, polyallyl amine, polylysine and co-polymers, polymers containing Sulphur or thiol groups such as polystyrene sulfonates, polysulfides, polysulfones and co-polymers, Silica, oleic acid, myristic acid, octanoic acid, steraic acid, any other organic cabroxylic acid, oleylamine, butylamine, any other organic amine, trioctylphosphine oxide, any other organic phosphine oxide, 1-octadecanethiol, dodecanethiol, any other organic thiol, 3-mercapopropionic acid, any other functionalized organic thiol, hydroxide, acetate ion, iodine ion, bromine ion, chlorium ion, sulfur ion, trioctylphosphine, any other organic phosphine, trioctylamine, Triphenylphosphine, any analogues of the above and any combination of all of the above.

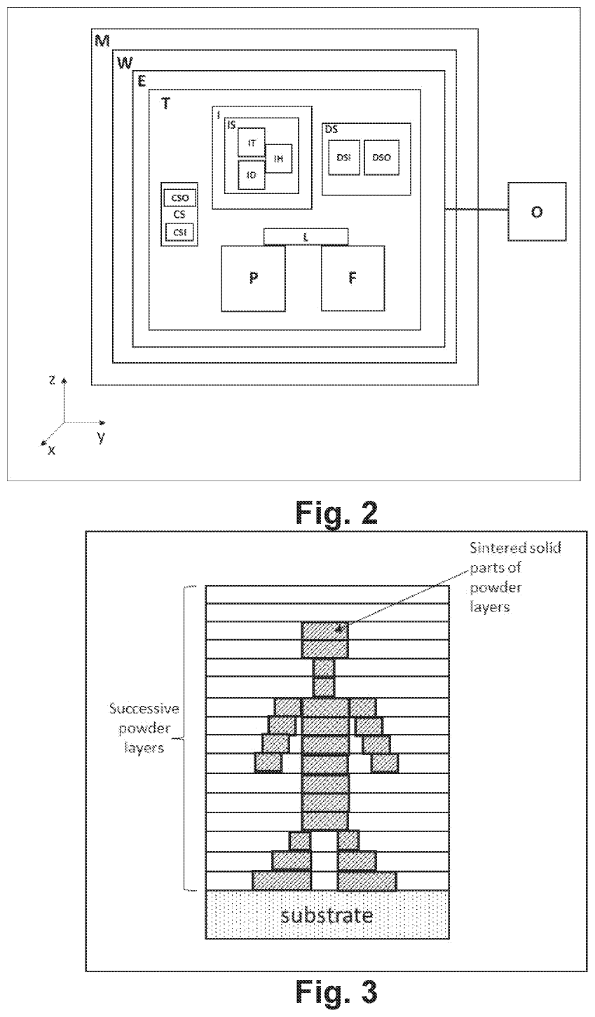

The method of the first aspect of the present invention can be used for printing 3D projects and as mentioned earlier, this can happen through a layer-by-layer deposition fabrication methodology. For example, the method can be applied for 3D printing using the system of the second aspect of the present invention, some components of which are schematically shown in FIG. 2 for an embodiment. The system operates as follows: a thin layer of powder of material A or A+B mixture is applied on the printing region of the system which is located in the printing region system called P. The layer is formed using a layer forming system called L. System L may take powder from a feedstock system of powder, this system is called F. The powder may consists of particulates/granules) the size of which may be 0.001-1000microns, and preferably be 0.001-100microns. The thickness of the powder layer may be 0.00001-10 centimetres, and preferably be 0.001-0.1 centimetres and most preferably be 0.001 to 0.01 centimetres. The temperature of the powder and the temperature of the powder layer in systems P, L, F may be controlled through the application of a heating or/and cooling system called system T. For example, a heating system may contain thermometers and temperature monitoring systems and electrical resistive heaters and/or IR heating lamps which heat the F, L, P and everything within them. When the powder layer is deposited, then material B may be deposited on the powder via a material deposition system I. If powder layer produced by L consists of pre-mixed A+B then I may not be necessary. If the photochromic or thermochromic properties of B may be enhanced when B is in contact with other material such as B2, B3 etc., then block I may be used to deposit B2, B3, etc. on the A+B powder layer. I may contain several tanks which may contain B, B2, B3 separately or combined. Deposition system I may contain a system of tanks called IT tanks in which colour pigments dissolved in liquids are deposited on the powder layer as to colour it. Such colour pigments can optionally exist in the same tanks with either B or B1, B2 etc. Deposition system I may contain a subsystem called ID for dropping droplets of any liquid contained in the tanks of the system as to deposit B, B2, B3 etc. or/and colours on the powder layer. For example, the subsystem ID may consist of an inkjet head or a multiple of inkjet heads each of which may be fed with liquid from one or more tanks. The inkjet heads may be physically attached to the tanks of IT or may connected to the tanks via a hydraulic system called IH. The deposition system ID or parts of it such inkjet heads may move across the x and y directions as to form deposition patterns on top of the powder layer. A subsystem called IS can be used for controlling the motion of any of I and any subsystem of it across the x, y, z axes. When system I deposits on the powder layer materials which may be dispersed in a liquid then the constituents of the liquids are selected and engineered as to achieve the following: i) the materials should be able to disperse within the liquid, ii) the liquid and its contents should be able to disperse across the cross section of the powder, and iii) the liquid will evaporate after being deposited. In the case that material B is a photochromic material, then before, during and after deposition of materials on the powder layer the powder layer or the materials may be irradiated with radiation C via a radiation C system called CS. CS may irradiate systems L, F P, I and preferably irradiates P or parts of it such as the upper surface of the powder layer. CS contains at least one source of radiation C and may contain a subsystem called CSI for controlling the intensity and spectral profile of radiation C. CS may also contain an optical subsystem called CSO which may serve various tasks such as focusing radiation C on the powder layer, or directing/allowing radiation C to illuminate only certain parts of the powder layer, such as areas of various geometrical shapes and patterns. In a non-limiting example of CSO, if the radiation C source is a laser, then CSO may include a set of galvo-mirrors that scan the laser beam across the x-y directions on the powder layer. CS may also contain a mechanical system which moves the radiation source across any of the x,y,z directions. In another example, CS may also contain sources of radiation C that are located inside or close to the tanks of IT or inkjet heads of ID or other parts of system I and subsystem ID as to irradiate material B before it has been deposited on the powder layer. If material B is a thermochromic material then system CS is optional.

After materials have been deposited on the powder layer and radiation C has altered the optical properties of material B then the powder layer is irradiated with radiation D which is provided by a system called DS. DS may illuminate systems L, F P, I and preferably illuminates P or parts of it such as the upper surface of the powder layer. DS contains at least one source of radiation D and may contain a subsystem called DSI for controlling the intensity and spectral profile of radiation D. DS may also contain an optical subsystem called DSO which may serve various tasks such as focusing radiation D on the powder layer, or directing/allowing radiation D to illuminate only certain parts of the powder layer, such as areas of various geometrical shapes and patterns. In a non-limiting example of DSO, if the radiation D source is a laser then DSO may include a set of galvo-mirrors which scan the laser beam across the x-y directions on the powder layer. DS may also contain a mechanical system which moves the radiation source across the x,y,z directions.

If material B is a photochromic material, then when the powder layer is irradiated with radiation D, the parts of the powder layer that contain material B, and have been irradiated with radiation C, and have been irradiated with radiation D, are sintered, because in those parts material B absorbs radiation D and is thus heated to temperatures above the sintering point of material A. If the material B is only a thermochromic material, then when the powder layer is irradiated with radiation D, the parts of the powder layer that contain material B, and have been heated to the temperatures required for changing the optical properties of material B as to be able to absorb radiation D, and have been irradiated with radiation D, are sintered.

The sintered solid parts of the powder layer consist of a composite material that contains at least materials A and B. The morphology of the final composite layer will depend on the morphology of the initial powder layer, the volume and deposition area of the ink which was deposited by the system I (if that was necessary) and the morphological changes that will be induced by the sintering process of both the polymer and the ink. Generally, the planar morphology of the initial powder layer is preserved and translated to a planar morphology of the sintered parts of the powder layer. The dimensions and shape of the final sintered parts may depend on: 1) the size and shape of the areas on which system I may have deposited material, 2) the size and shape of the areas which were irradiated by CS, 3) the size and shape of the areas which were irradiated by DS, 4) a combination of any of the above 1-3.

3D printing can occur though repetition of the method of the present invention, meaning that after parts of the powder layer have been sintered, then a new powder layer is deposited on top and the aforementioned processes are repeated. Every time the process is repeated, the sintered parts may also be sintered with -meaning strongly adhered to- the parts which were sintered at the previous powder layer, and the size and shape of the sintered parts of the powder layer can be different compared to the ones of the previous layer. This way, 3D dimensional objects of desired shapes and size are formed a shown in FIG. 3. The objects can be easily mechanically removed, e.g. by hand, from the un-sintered powder that surrounds them. The method of the present invention and any obvious variations of it can be combined, in a successive manner, with other additive manufacturing methods for making complex objects that contain, only partially, components which are made with our method.

The system that can be used for our implementing the method may contain additional components to the ones that were described above. A non-limiting list of such components are: a power system W which powers all other systems and subsystems of the system, an electronic system E which controls all other systems and subsystems of the system, a mechanical system M which contains all or some systems of the system, and a computer system O that controls system E.

By means of the present invention a solution is provided to the above mentioned problems associated to the prior art methods, i.e. to the fact that metallic plasmonic particles do tend to absorb in the visible and this problem can be further increased by the structural transformations of the particles which are induced by the high temperatures at which 3D printing occurs.

Herein, experimental evidence is provide of the method of the first aspect of the invention, using photochromic nanomaterials.

For obtaining said experimental evidence, a specific example of photochromic material B was developed by the present inventors for use with the method of the present invention, particularly tungsten oxide nanoparticles. The present inventors synthesized the nanoparticles by adopting a colloidal method from the scientific literature (Solid State Sciences, 69, 50-55, 2017) for fabricating good colloidal suspensions of this material at quantities which are high enough for use in 3D printing. The method can be scaled up for industrial production. A particularly nice aspect of the synthetic method is that it is relatively green since no highly toxic chemicals are used and the main solvents used are: water, ethanol, glacial acid (which is a weak acid).

Specifically, the above referred colloidal method comprises the following steps: in a flask with a condenser attached to it, the present inventors mixed 0.2 g of tungsten chloride and 100 ml of ethanol. Then the flask was heated under stirring to reflux of its contents. The liquid in the flask became clear yellow due to dissolution of the tungsten chloride. Then a mixture of 6 ml water and 2 ml acetic acid was quickly injected in the flask, using a 12 ml syringe. The colour of the liquid of the flask became instantly deep blue due to formation of tungsten oxide nanoparticles with a stoichiometry of WOₓ where x<3. The solution was kept to reflux for 1 hour and was then cooled down.

The nanoparticles of the solution were then isolated from the liquid by centrifuging the solution to which 30 ml of hexane had been added. After centrifugation, the nanoparticles had formed a blue solid precipitate, which was further washed with ethanol and ultimately was re-dispersed in ethanol. The WO₃ nanoparticles are ligand free, and immediately after synthesis they exhibit a deep blue colour. This implies that they are non-stoichiometric and, as stated above, their chemical formula is WOₓ where x<3. Due to this stoichiometric imbalance, the nanoparticles behave as heavily charged semiconductors and for this reason they exhibit a broad, but rather distinctive, plasmon peak centred at 1000-1100nm.

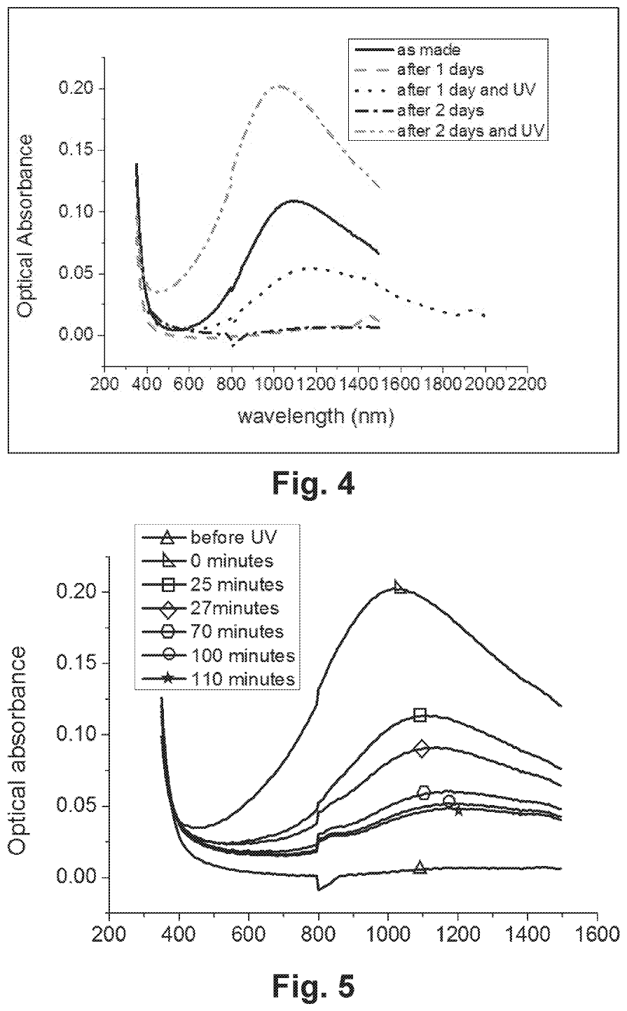

When this solution is left in ambient environmental conditions for 1 day its colour changes from blue to faintly yellow-bronze colour and it also turns from non-transparent to transparent due to oxidation of the nanoparticles. This results to loss of the plasmon peak of the particles. When the solution of the nanoparticles is exposed to UV light coming from a UV-lamp, its colour turns again back to the original one, which is blue and non-transparent, because UV-light induces a partial loss of oxygen from the nanoparticles structure. This phenomenon is a rather impressive manifestation of the photochromic effect which is well known for WO₃. If the solution is again left to ambient conditions it becomes transparent and in general the aforementioned steps can be repeated several times for changing the optical properties of the nanoparticles from one form to the other, as shown in FIG. 4. Then, the nanoparticles can be sequentially coloured, decoloured, coloured and so on.

Trying to understand in detail the photochromic behaviour of this nanomaterial and its potential application for 3D printing, the present inventors performed a series of optical and photothermal characterization of WO₃ colloidal solutions, and polymer-WO₃ NP composites, which results are discussed below.

1. Colour Cycling of colloidal solutions: As stated above, FIG. 4 shows the colour of the WO₃ suspension in ethanol before UV treatment and after UV treatment. The macroscopically observed transient photochromic behaviour of the material, is further confirmed by the absorption spectra of 1 g/L solutions. The spectra were taken over the period of 3 days before and after UV treatment. The following main observations can be made: the plasmon peak is fully re-covered, strengthened and blue shifted after UV-treatment, then fully lost upon 1 day aging.

2. Transient character of plasmon peak: The transient character of the plasmon peak of the material was studied via monitoring the evolution of the plasmon peak after UV treatment. The spectra are shown in FIG. 5 and the main observation is that half of the plasmon peak is lost in the first 20 minutes after UV radiation, while subsequent degradation of the plasmon peak happens at a slower rate.

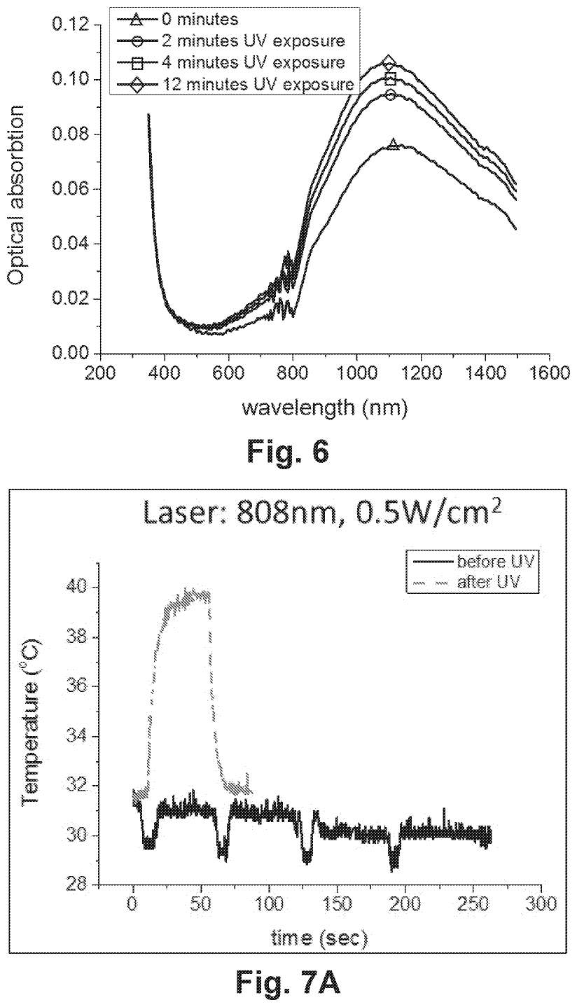

3. In-situ observation of photochromism: The photochromic effect was observed in-situ by adding a 365 nm portable UV-lamp inside the sample chamber of the spectrophotometer. Prior to the measurements, the sample was already partially photodoped. Additional photodoping was observed as a function of UV-exposure time. The results are shown in FIG. 6. The main conclusions are that photodoping is cumulative and that for best utilization of the photodoping (photochromic) effect the nanoparticles must be illuminated with UV while photochromism is being utilized. In other words, photochromism can be best used for printing, via using a printer in which nanoparticles are irradiated with UV light (for photodoping) before and while being sintered with IR light.

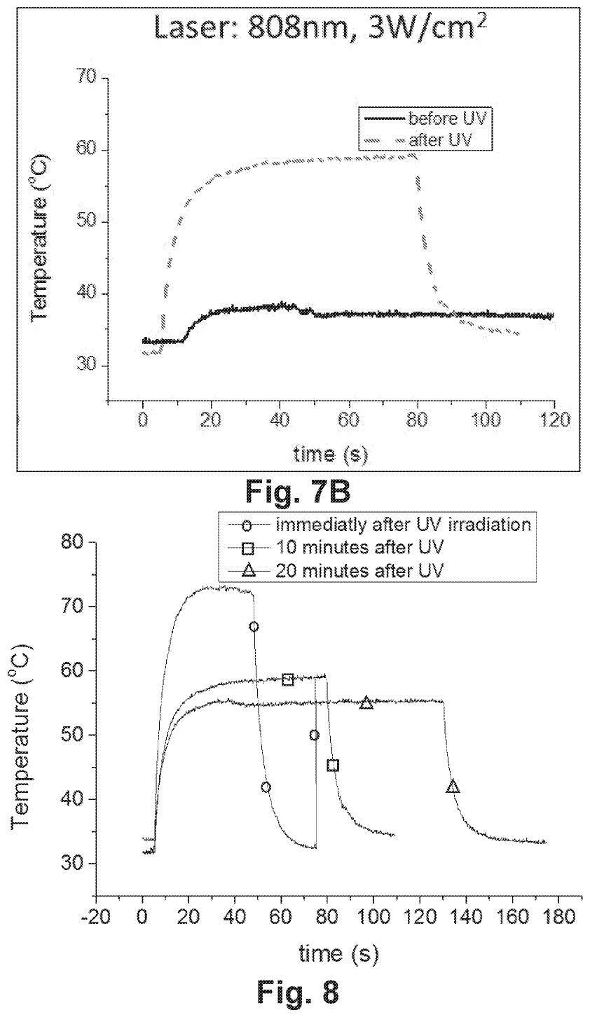

4. Photothermal effect of solid samples at room temperature: The photothermal effect at room temperature of WO₃ drop casted on polymer PA12 powder was monitored before and after UV-illumination. Results are shown in FIGS. 7A and 7B and it is obvious that UV-induced photochromism is required for acquiring a technologically relevant photothermic response from the nanoparticles. Specifically, the present inventors mixed the nanoparticle/ethanol solution with powder of PA12 (which is a polymer also known as nylon 12) which can be considered as an example of material A in the present invention. The mixture was left until the ethanol from the nanoparticle solution evaporated and the nanoparticle/PA12 composite was dry. The WOₓ/PA12 weight ratio of the composite was 1:1000. The present inventors then formed thin disks of this powder. Then the powder disks were exposed to 808 nm laser light which is an example of electromagnetic radiation D in the present invention. The temperature of the powder was monitored using a thermal camera and found that the powder's temperature did not increase. Then the laser was switched off, and the powder was irradiated with UV light produced by a UV lamp which was located close to the powder. The UV light in this case is an example of radiation C in the present invention. Then the powder was irradiated again with the laser and found that this time the powder's temperature increased by more than 30° C., as shown in FIGS. 7A and 7B. This happened because of the photochromic properties the WO, nanoparticles which upon exposure to UV light became blue and developed a plasmon absorption peak in the infrared part of the spectrum. As result of that, the UV-illuminated nanoparticles of the powder could subsequently absorb the laser beam and be heated thus also heating the PA12 content of the powder. A similar experiment was performed but at elevated baseline temperature of the powder, namely at 168° C. which is below the sintering point of the PA12 powder which can be sintered at temperatures >180° C. It is noted that the powder was heated to 168° C. via thermal convection due to positioning the powder on the hot surface of a hotplate and by additionally illuminating the surface of the powder with IR light coming from a set of IR heating lamps. Then, the powder was first illuminated with UV light and then irradiated with the 808 nm laser beam of a 3 W/cm² power density, the temperature of the powder was increased to >180° C. resulting to sintering and/or melting of the polymer. When the laser was turned off, the sintered area of the powder cooled down and now appeared as solid object. When the powder is not illuminated with UV light prior to being irradiated with the laser, then it cannot be heated to the temperatures required for sintering of the powder.

5. Transient character of photothermal property of solid samples: The photothermal properties of the aforementioned samples, was further studied as a function of time elapsed since UV-exposure. The results are shown in FIG. 8. The main conclusion is that at room temperature the photothermal property of photodoped samples is partially preserved for several minutes after UV-exposure.

Specifically, it can be stated that when the UV light is turned off the coloration of the WOₓ nanoparticles does not change instantly, instead a few seconds or minutes or hours are required depending on various parameters such as the atmospheric conditions, such as the humidity and oxygen content of the atmosphere, the morphology and exact stoichiometry of the nanoparticles, the presence of any materials around the nanoparticles that may hinder or accelerate the changes of the optical properties and the temperature of the nanoparticles and the medium they are in. For example, it was found that a solid object of WOₓ/PA12 is originally white and has the same colour as a solid object which is made only of PA12. When the WOₓ/PA12 and PA12 objects are irradiated with UV light, the PA12 object remains white while the WOₓ/PA12 object it becomes blue due to the photochromic effect of the WOₓ nanoparticles. If this blue object is left at room temperature it becomes white again over a period of 1 day. Instead, if the blue object is heated to 150° C., it becomes white within 30 seconds due to an accelerated oxidation of the WOₓ particles at elevated conditions and under ambient atmosphere. Similarly, it was found that the time required for the WOₓ nanoparticles to develop a plasmon absorption peak in the IR, and the intensity and centre of this peak depend on the temperature of the nanoparticles or the nanoparticles/polymer mixture and the intensity of the UV light. Therefore, in the method of the present invention the temperature of materials A, B or A+B mixture before, during and after the sintering process may be controlled as to control the photochromic or photothermic response and optical properties of material B or of the A+B mixture. In addition, the atmospheric conditions of materials A, B or A+B mixture before, during and after the sintering process may be controlled as to control the photochromic or thermochromic responses of material B or the A+B mixture. In addition the time of duration of exposure of material B or material A+B to radiation C and the intensity and spectral profile of radiation C before, during and after the sintering process, may be controlled as to control the photochromic or thermochromic responses of material B or the A+B mixture.

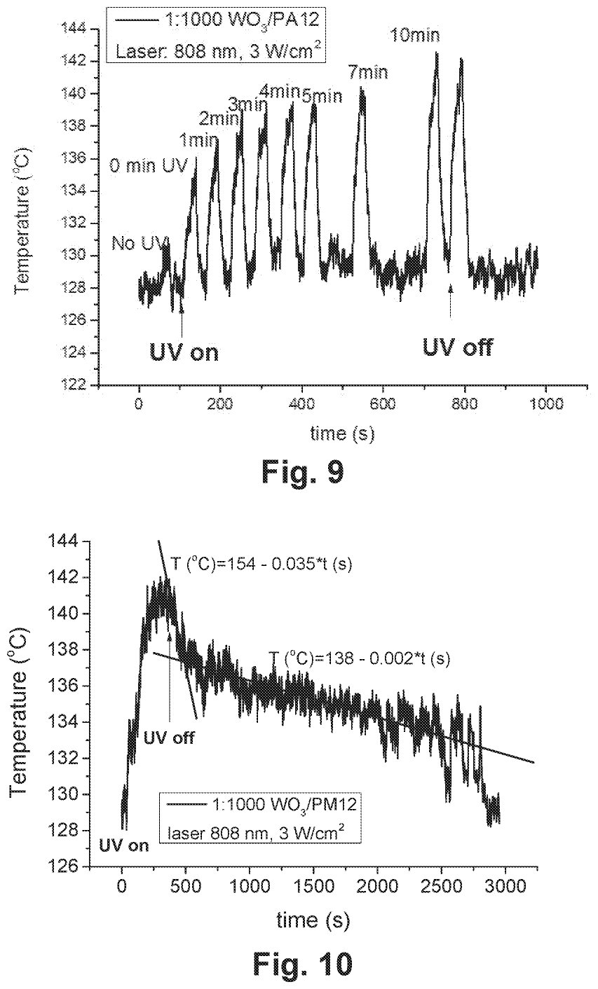

6. Photochromism and photothermal behaviour at 125° C. with in situ UV: 3D printing using SLS typically happens at elevated baseline temperatures in the 140-170° C. range. For this reason, it is imperative to study photochromism and related photothermal properties at high temperatures. Hence, the present inventors prepared WO₃/PA12 powder mixtures of 1:1000 weight ratio and positioned them on a hotplate. The temperature of the hotplate was set to 170° C., but the temperature of the powder surface was 125° C. The photothermal effect with and without UV irradiation was recorded, and depicted in the graph of FIG. 9. It is important to note that in this case UV-irradiation was provided in-situ from a UV lamp positioned at the side of the hotplate. That allowed to monitor the photothermal response as a function of the irradiation time. The main conclusions are that photochromism does happen at 125° C. but the overall effects are less pronounced compared to when the materials are at room temperature. Possible explanations for this difference is that high temperatures favour oxidation of the nanoparticles which acts against photochromism. In addition, at high temperatures the sample is dryer and many believe that the presence of water is associated with photochromism of WO₃ nanoparticles. Another conclusion from this experiment is that the photochromic (photodoping) effect is cumulative and does not wear off upon heating the particles with the laser. In addition, as already stated above, the effect is preserved for at least few seconds-minutes after UV is off. Lastly, for the particular UV lamp used here, the photodoping effect saturates after about 5 minutes.

7. Kinetics of degradation of photodoping-photothermal effect after UV-irradiation at 125° C.: Since photochromism and the associated photothermal behaviour of WO₃ nanoparticles are transient effects, it is important to study their evolution after UV light is off. It is further meaningful to do this at elevated temperatures since these are usually used for 3D printing. Thus, it was measured how the IR laser induced temperature rise of a 1:1000 WO₃/PA12 powder drops after UV light is off. The results are shown in FIG. 10 and from there it is quite clear that two main time-regions can be distinguished. One where photothermal degradation is fast and one where degradation is slow. At first approximation, these regions can be described as linear.

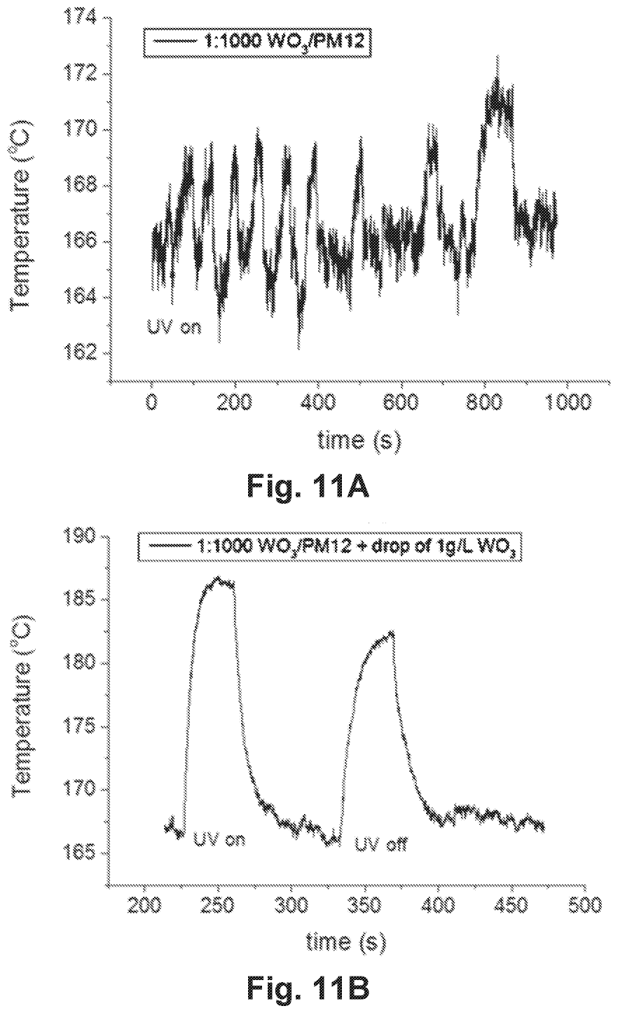

8. Photochromism and photothermal behaviour at 168° C. with in situ UV: The apparatus including a hot plate, used in items 6 and 7 above, was further modified by adding an IR heating lamp array for raising the surface temperature of the powder bed to ≈170° C. which is the one typically used in SLS of carbon black-nylon. The photothermal behaviour of the 1:1000 WO₃/PA12 is shown in FIG. 11A. It is obvious that the temperature rise is very small which further confirms our previous observation on the decrease of photothermal response with increasing temperature. For this reason, the concentration of the nanoparticles was further increased by dropping on the powder bed a drop of 1 g/L WO₃/ethanol. For this modified sample, as shown in FIG. 11B, temperature rises of 20° C. under 3 W/cm² 808nm laser were observed, and UV-induced photochromism is required for achieving a good photothermal response.

9. Transient Photochromism on objects: A likely implication of photochromism is that the colour of printed objects will be improving with time due to disappearance of the colour of the WO₃ nanoparticles after the printing process is complete. To demonstrate that, some WO₃ and PA12 (1:1000 weight ratio) were melted together, and its colour was observed before UV light, after UV light, and after 1 day of aging at ambient (indoors) lighting conditions. The obtained results confirmed the above mentioned implication.

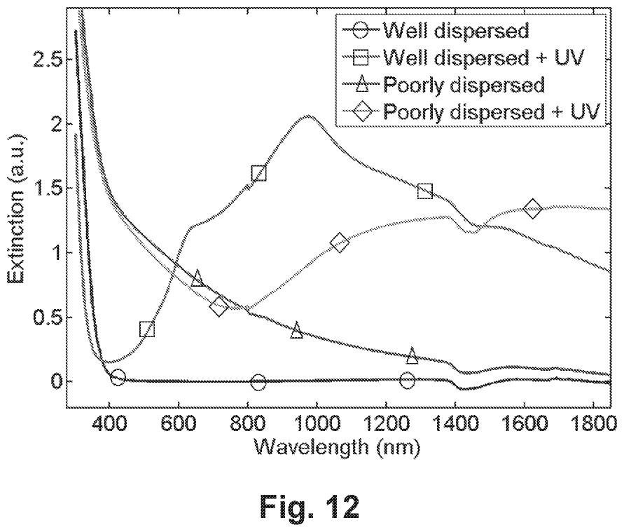

Finally, FIG. 12 is a diagram showing optical absorption waveforms of well and poorly dispersed second material particles, specifically for WO₃ particles (small particles with an average diameter around 5 nm), used herein to complement the definition given in a previous section in this document regarding the importance of the term “well dispersed” for the definition of the terms “strong” and “non-strong” optical absorption properties.

As stated in that previous section, it is important to note the term “well dispersed” for the above given definition of “strong” and “non-strong” optical absorption properties.

A solution of small nanoparticles (<25 nm average diameter) that is well dispersed should appear clear or coloured but still transparent at certain wavelengths, i.e. it should not appear cloudy, and one should be able to clearly see objects on the far side. That is, assuming the solution itself is transparent. One could potentially do these experiments for particles in a polymer matrix, but many polymers absorb slightly and so will not appear transparent anyway.

For larger nanoparticles, (>25 nm average diameter), there may be some scattering present due to the size of the particles. A broader definition of “well dispersed” that also covers this case is “Particles that maintain a large enough distance from each other so as to not significantly effect each other's optical properties in terms of scattering and/or absorption”.

The reason this is important is that in many experiments, if one has a highly scattering sample, and does not try to account for this, then one will measure the scattering as absorption and so poorly dispersed nanoparticles can appear to be better absorbers than well dispersed particles, even if this is not the case. The present inventors have found that for some samples of the second material that are not well dispersed, one gets agglomerations, leading to large scattering. So if one is not careful it can look like the absorption is very high for the “non-strong” sample.

FIG. 12 is a good example of this. The WO₃ nanoparticles are about 5 nm in diameter, and if well dispersed, in their “non-strong” absorption state (waveform with circle marks) they absorb almost nothing up until their bandgap below 400 nm. As there is virtually no absorption above 400 nm for these particles, it can be stated that the scattering is negligible. On UV excitation (used as an example of stimulus for inducing the chromic effect), the extinction increases is suddenly more than 100 times (waveform with square marks).

In the poorly dispersed case (waveform with triangle marks), the extinction (absorption+scattering) is quite high up to about 1400 nm, due to large amounts of scattering due to the large size of the agglomerated particles. Therefore if one measures the increase in extinction after UV illumination (waveform with rhombus marks) at the peak wavelength of an NIR lamp at 1100 nm, then one might only see an increase by a factor of 2 or 3.

This is due to the high scattering one starts with in this case. If one were to use a more specialised apparatus like an integrating sphere then one would see that the absorption in the weak absorption case is very low. If one takes these particles and re-disperse them, then one returns to something like the waveform with circle marks. Therefore defining the above numbers (i.e. those given for defining the “strong” and “non-strong” optical absorption properties) in terms of being “well dispersed” is crucial. This is also the case for larger particles ((>25 nm average diameter).

A person skilled in the art could introduce changes and modifications in the embodiments described without departing from the scope of the invention as it is defined in the attached claims. For example, a method or system as the ones of the present invention which comprises the use of any type of radiation (such as ultrasound, thermal, electric, electrostatic, magnetic, or ionizing radiation), electromagnetic or of another kind, to expose the strong optical absorbent particles, which are well known in the art for exciting such kind of particles causing them to generate heat, is to be considered equivalent to the one of the present invention.

### REFERENCES

[1] Salje & B Guttler, Anderson transition and intermediate polaron formation in WO3-x Transport properties and optical absorption, Philosophical Magazine B, (1984).

[2] Li et al, A plasmonic non-stoichiometric WO3-x homojunction with stabilizing surface plasmonic resonance for selective photochromic modulation, Chemistry Communications (2018), DOI: 10.1039/C8CCO2211A

[3] Zheng et al, The preparation of a high performance near-infrared shielding CsxWO3/SiO2 composite resin coating and research on its optical stability under ultraviolet illumination, Journal of Materials Chemistry, (2015).

1. A method for producing a three-dimensional object, comprising:
providing a first material in a non-continuous solid form;
providing a second material on at least a region to be at least partially fused of said first material, wherein said second material exhibits strong optical absorption properties at a specific wavelength which make the second material be a strong optical absorber; and
exposing said second material to electromagnetic radiation having said specific wavelength, to be absorbed thereby to photothermally generate heat to fuse at least those portions of the first material in thermal contact with the second material,
wherein the method further comprises:
providing as said second material a reversible chromic material which changes its optical properties induced by a stimulus, from non-strong optical absorption properties or substantially non-strong optical absorption properties, at said specific wavelength, to said strong optical absorption properties at said specific wavelength; and
applying at least said stimulus to the second material to temporarily change its optical properties to said strong optical absorption properties at said specific wavelength, wherein at least said stimulus is applied before and/or during at least part of the time during which the second material is exposed to said electromagnetic radiation.

2. The method according to claim 1, wherein said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

3. The method according to claim 1, wherein said strong optical absorption properties are optical polaronic properties, said strong optical absorber is an optical polaronic absorber, said non-strong optical absorption properties are non-strong optical polaronic properties, and said substantially non-strong optical absorption properties are substantially non-strong optical polaronic properties.

4. The method according to claim 1, wherein said strong optical absorption properties comprise optical resonant properties and optical polaronic properties, said strong optical absorber is both an optical resonance absorber and an optical polaronic absorber, said non-strong optical absorption properties comprise optical non-resonant properties and non-strong optical polaronic properties, and said substantially non-strong optical absorption properties comprise optical substantially non-resonant properties and substantially non-strong optical polaronic properties.

5. The method according to claim 1, wherein said reversible chromic material is one of:
a thermochromic material, and said stimulus is a thermal stimulus; and
a photochromic material, and said stimulus is an electromagnetic radiation stimulus.

6. (canceled)

7. The method according to claim 1, wherein said reversible chromic material is excitable by different types of stimuli and/or comprises a combination of chromic materials differing in that they are excitable by different types of stimuli, wherein said step of applying at least said stimulus to the second material comprises applying, sequentially or simultaneously, stimuli of said different types to the second material.

8-11. (canceled)

12. The method according to claim 1, comprising applying the stimulus or stimuli during all of the time during which the second material is exposed to said electromagnetic radiation.

13. The method according to claim 3, wherein the second material has a crystal lattice with defect sites, wherein the optical polaronic absorption comprises the absorption of the optical energy needed to move an electron between said defect sites.

14. The method according to claim 2, wherein the optical resonance of the optically resonant absorber refers to at least one of the following types of optical resonances: plasmonic resonance, Mie resonance, whispering gallery modes, optical resonance due to electronic transitions of charge carriers from one energy state or band in the electronic structure of the second material to another one upon absorption of photons, or a combination thereof.

15. (canceled)

16. The method according to claim 1, wherein the second material also comprises non-chromic materials, said non-chromic materials being adapted and arranged to enable or enhance the chromic response of the chromic material or chromic materials.

17. (canceled)

18. The method according to claim 1, wherein the second material includes at least one of the following materials: vanadium oxide, tungsten oxide, aluminium doped zinc oxide, tin doped indium oxide, cesium doped tungsten oxide, copper doped tungsten oxide, potassium doped tungsten oxide, sodium doped tungsten oxide, silver doped tungsten oxide, or a combination thereof.

19. The method according to claim 1, wherein both said non-strong optical absorption properties and said substantially non-strong optical absorption properties provide an optical absorption coefficient for the second material, at said specific wavelength, which is less than 1 L.g⁻¹.cm⁻¹, preferably less than 0.5 L.g⁻¹.cm⁻¹ and more preferably less than 0.1 L.g⁻¹.cm⁻¹, and wherein the absorption coefficient provided by the strong optical absorption properties to the same second material at the same specific wavelength, after being stimulated by said stimulus, exhibits an absorption coefficient which is greater than 2 L.g−1.cm−1, preferably greater than 3 L.g−1.cm−1, and more preferably greater than 5 L.g−1.cm−1.

20. The method according to claim 1, comprising producing a 3D object using a layer-by-layer deposition process, by forming a base layer by fusing together said at least those portions of the first material in thermal contact with the second material from the photothermal heat generated thereby, providing at least a further first material supply over the already formed base layer, and then fusing together a region of said further first material supply by applying a further second material supply thereon, applying thereon at least said stimulus and exposing to electromagnetic radiation having said specific wavelength the further second material supply.

21. A system for producing a three-dimensional object, comprising:
at least one supplier device for providing:
a first material in a non-continuous solid form; and
a second material on at least a region to be at least partially fused of said first material, wherein said second material exhibits strong optical absorption properties at a specific wavelength which make the second material be a strong optical absorber;
a controllable radiation source for exposing said second material to electromagnetic radiation at said specific wavelength, to be absorbed thereby to photothermally generate heat to fuse at least those portions of the first material in thermal contact with the second material;
a supply of said second material, to feed said at least one supplier, in the form of a reversible chromic material which changes its optical properties induced by a stimulus, from non-strong optical absorption properties or substantially non-strong optical absorption properties, at said specific wavelength, to said strong optical absorption properties at said specific wavelength;
a stimulus source configured and arranged to apply at least said stimulus to the second material to temporary change its optical properties to said strong optical absorption properties at said specific wavelength; and
at least one controller adapted to control said at least one supplier device to provide the first and the second materials, said controllable radiation source to emit said electromagnetic radiation at said specific wavelength to expose the second material thereto, and said stimulus source to apply at least said stimulus to the second material before and/or during at least part of the time during which the second material is exposed to said electromagnetic radiation at said specific wavelength.

22. The system according to claim 21, wherein said strong optical absorption properties are optical resonant properties, said strong optical absorber is an optical resonance absorber that optically resonates when exposed to said electromagnetic radiation to produce said photothermal heat generation, said non-strong optical absorption properties are optical non-resonant properties, and said substantially non-strong optical absorption properties are optical substantially non-resonant properties.

23. The system according to claim 21, wherein said strong optical absorption properties are optical polaronic properties, said strong optical absorber is an optical polaronic absorber, said non-strong optical absorption properties are non-strong optical polaronic properties, and said substantially non-strong optical absorption properties are substantially non-strong optical polaronic properties.

24. The system according to claim 21, wherein said strong optical absorption properties comprise optical resonant properties and optical polaronic properties, said strong optical absorber is both an optical resonance absorber and an optical polaronic absorber, said non-strong optical absorption properties comprise optical non-resonant properties and non-strong optical polaronic properties, and said substantially non-strong optical absorption properties comprise optical substantially non-resonant properties and substantially non-strong optical polaronic properties.

25. A package for producing a three-dimensional object, comprising, enclosed therein:
a first material in a non-continuous solid form; and
a second material which exhibits strong optical absorption properties which make the second material be a strong optical absorber;
wherein said second material is a reversible chromic material which changes its optical properties induced by a stimulus, from non-strong optical absorption properties or substantially non-strong optical absorption properties, at said specific wavelength, to said strong optical absorption properties at said specific wavelength, and wherein the package is configured and arranged to cooperate with at least one supplier device of system for producing a three-dimensional object for providing the first and second materials extracting them from the package, wherein said system for producing a three-dimensional object comprises:
at least one supplier device for providing:
a first material in a non-continuous solid form; and
a second material on at least a region to be at least partially fused of said first material, wherein said second material exhibits strong optical absorption properties at a specific wavelength which make the second material be a strong optical absorber;
a controllable radiation source for exposing said second material to electromagnetic radiation at said specific wavelength, to be absorbed thereby to photothermally generate heat to fuse at least those portions of the first material in thermal contact with the second material;
a supply of said second material, to feed said at least one supplier, in the form of a reversible chromic material which changes its optical properties induced by a stimulus, from non-strong optical absorption properties or substantially non-strong optical absorption properties, at said specific wavelength, to said strong optical absorption properties at said specific wavelength;
a stimulus source configured and arranged to apply at least said stimulus to the second material to temporary change its optical properties to said strong optical absorption properties at said specific wavelength; and
at least one controller adapted to control said at least one supplier device to provide the first and the second materials, said controllable radiation source to emit said electromagnetic radiation at said specific wavelength to expose the second material thereto, and said stimulus source to apply at least said stimulus to the second material before and/or during at least part of the time during which the second material is exposed to said electromagnetic radiation at said specific wavelength.

26. A sensing device comprising a three-dimensional object manufactured according to a method for producing a three-dimensional object, comprising:
providing a first material in a non-continuous solid form;
providing a second material on at least a region to be at least partially fused of said first material, wherein said second material exhibits strong optical absorption properties at a specific wavelength which make the second material be a strong optical absorber; and
exposing said second material to electromagnetic radiation having said specific wavelength, to be absorbed thereby to photothermally generate heat to fuse at least those portions of the first material in thermal contact with the second material,
wherein the method further comprises:
providing as said second material a reversible chromic material which changes its optical properties induced by a stimulus, from non-strong optical absorption properties or substantially non-strong optical absorption properties, at said specific wavelength, to said strong optical absorption properties at said specific wavelength; and
applying at least said stimulus to the second material to temporarily change its optical properties to said strong optical absorption properties at said specific wavelength, wherein at least said stimulus is applied before and/or during at least part of the time during which the second material is exposed to said electromagnetic radiation,
wherein in the sensing device the second material is arranged within the three-dimensional object so that its optical properties change from non-strong optical absorption properties or substantially non-strong optical absorption properties, at said specific wavelength, to strong optical absorption properties at said specific wavelength upon detection of a stimulus inducing said change, so that phenomena causing said stimulus can be sensed.

27. The sensing device according to claim 26, further comprising associated measuring components to measure said sensed phenomena.
